(19) United States
(12) Patent Application Publication
(10) Pub. No.: US 2007/0128368 A1
(43) Pub. Date: Jun. 7, 2007

(54) Method for production of functional film, substrate conveyance apparatus, and functional film produced with the method

(75) Inventors: Daiki Minamino, Tokyo (JP); Takeshi Tanaka, Kobe-shi (JP); Koji Nakashima, Kobe-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 11/604,481

(22) Filed: Nov. 27, 2006

(30) Foreign Application Priority Data
Dec. 6, 2005 (JP) JP2005-351827

(51) Int. Cl. B05C 3/12; B05C 13/02

(52) U.S. Cl. 427/377; 118/58; 118/420

(57) ABSTRACT

A method for producing a functional film having the steps of: (a) forming a coated layer with a coating solution onto a substrate, and (b) drying the coated layer while the substrate is conveyed in a floating state by blowing a gas to an uncoated surface of the substrate from a plurality of blowing outlets arranged along the direction of the conveyance of the substrate, wherein the conveyance apparatus features alternately squared notches and raised portions having the blowing outlets, and in a plurality of the adjacent raised portion and the squared notch, the gas is blown from the blowing outlets to make a difference of back pressure between the raised portion and the uncoated surface of the substrate and the back pressure between the squared notch adjacent to the raised portion and the uncoated surface of the substrate to be between 10-1,000 Pa.

This application is based on Japanese Patent Application No. 2005-351827 filed on Dec. 6, 2005, in Japanese Patent Office, the entire content of which is hereby incorporated by reference.

### FIELD OF THE INVENTION

The present invention relates to methods for producing a functional film with a conveyance system in which the substrate of the functional film is conveyed while floating, and to a method for conveying the substrate, and also to a functional film featuring a hard-coat layer and an antireflective layer which is produced with the foregoing methods.

### BACKGROUND OF THE INVENTION

Various conventional methods have been proposed to apply a coating solution onto a belt-like substrate running on a continuous basis. For example, such a coating method is discussed in the “Modern Coating and Drying Technology” co-authored by Edward Cohen and Edgar Gutoff. Not only a single layer coating technique, but also a technique for simultaneous coating of multiple layers are commonly known, wherein the latter technique uses a coating die featuring slits, as in a slide coater, extrusion coater and curtain coater.

The devices of an electro-optic panel represented by a silver halide photosensitive material for general and industrial use, heat-sensitive material, heat development photosensitive material, photo-resist, a liquid crystal display (hereinafter, referred to as a LCD) and Organic electroluminescence (hereinafter, referred to as an organic EL) are produced by a process wherein an organic solvent-based or water-based coating solution is applied by a coater onto a belt-like substrate being continuously conveyed so that a coated layer surface is formed, and the belt-like substrate carrying the coated layer is then dried in a drying apparatus.

Various techniques discussed in the foregoing “Modern Coating and Drying Technology” co-authored by Edward Cohen and Edgar Gutoff have been proposed as the methods for applying a coating solution onto a continuously running belt-like substrate which is then dried thereafter. The most common drying technique is to supply hot air, into a closed drying box and to thereby dry the coated layer, and to discharge the vaporized solvent together with the gas flow out of the system. Further, when a combustible organic solvent is used, inert gas instead of ambient air is supplied to greatly reduce the possibility of an explosion. Such an apparatus with safety considerations is also disclosed in the above cited document. The present invention is applicable to the method and apparatus capable of drying by hot gases, independently of whether air or inert gas.

The drying process is very important, in that the properties of the coated surface are affected immediately after coating when the film surface is exposed to the heated atmosphere. Generally, commonly known problems of the surface of the coated layer during the drying process are that the coated surface is disturbed by contact with gas flow, the surface smoothness is deteriorated and so-called mottling is produced, so that uneven drying results due to the variations in temperature and volume of gas in the drying process. These problems tend to occur particularly when an organic solvent is used as the solvent of the coating solution.

It is also known that, if drying is not normally carried out, irregularities or other defects will over time occur to affect the external appearance of the coated layer having been produced. Thus, the final quality of the coated layer will be adversely affected by an inadequate amount of residual solvent contained in the coated layer, and variation in the amount of any residual solvent.

So far a great number of attempts have been made while studying methods of drying the surface of a coated layer. The following known example can be cited, in which a dry gas is blown from the opposite surface of the substrate carrying a coated layer and the coated substrate is conveyed in a floating state, and drying air is supplied to the surface of the coated layer. Thus, the width of a plurality of dry air supply apparatuses can be not much greater than that of the coated layer surface, and any excess amount of drying air of both edges of the coated layer across the width is minimized, whereby irregularities in the vicinity of both edges of the coated layer across the width become negligible, (please refer to Patent Document 1).

Compared to the drying apparatus based on the conventional roll conveyance method, the drying method described in Patent Document 1 provides an effective technique as a solution to the problem affecting the coated layer surface, but results in the following problems: (1) Disturbance of the coated surface caused when the drying gas supplied to float the coated substrate reaches the surface of the coated layer. (2) Disturbance of the coated layer surface caused by any vibration of the substrate due to an excess amount of the drying gas supplied to float the coated substrate when blown against the rear of the coated substrate. (3) Any instability in the process of floating the coated substrate.

A sufficient solution to the problem has not yet been found for the production of a functional film required in the electro-optic panel devices represented by LCDs and organic ELs where still higher quality is being desired. At present, the quality inspection of the finished product is performed, and the problem is somewhat solved at the sacrifice of the production efficiency. To overcome the current situation, it is expected to find a coated layer drying method to produce a functional film of higher quality at higher productivity, without depending on such quality inspection.

[Patent Document 1] Japanese Translation of PCT International Application Publication No. 2001-506178

### SUMMARY OF THE INVENTION

An object of the present invention is to solve the above described problems and to provide methods for producing a functional film of higher quality at higher productivity, when evaporating on a continuously conveyed belt-like substrate any solvent from the coated layer formed by application of a coating solution prepared by dissolving and dispersing a solid in a solvent. At the same time, another object of the present invention is to provide an apparatus to convey the foregoing substrate, a coated layer drying method and a drying apparatus for the foregoing procedure, as well as an optical material produced by using these methods and apparatuses.

### BRIEF DESCRIPTION OF THE DRAWINGS

FIG. 1 is a schematic diagram showing a coating/drying apparatus.

FIG. 2 are enlarged schematic diagrams of the conveyance apparatus of FIG. 1.

FIG. 2(a) is an enlarged schematic diagram represented by portion P in FIG. 1.

FIG. 2(b) is an enlarged schematic diagram represented by portion Q in FIG. 2(a).

FIG. 3 is a schematic expansion plan of the conveyance apparatus of FIG. 1.

FIG. 4 is a schematic cross-sectional view taken along arrow line AA′ of FIG. 1.

### MEANS FOR SOLVING THE PROBLEMS

The above objects of the present invention can be achieved by the following embodiments.

Item 1. A method for producing a functional film comprising the steps of:

(a) forming a coated layer by coating with a coating solution onto a substrate being belt-like and continuously conveyed, and the coating solution containing solid components dissolved or dispersed in a solvent, and

(b) drying the coated layer while the substrate with the coated layer is conveyed by supporting in a floating state by blowing a gas to an uncoated surface of the substrate from a conveyance apparatus having a plurality of blowing outlets arranged along the direction of the conveyance of the substrate in a drying process for producing a functional film by removing by evaporation of the solvent from the coated layer,

wherein the conveyance apparatus features alternately squared notches and raised portions having the blowing outlets, and in a plurality of the adjacent raised portions and the squared notches, the gas is blown the blowing outlets in order to make a difference between (1) and (2) to be not less than 10 Pa and not more than 1,000 Pa; wherein (1) is the back pressure generated between the raised portion and the uncoated surface of the substrate, and (2) is the back pressure generated between the squared notch adjacent to the raised portion and the uncoated surface of the substrate.

Item 2. The method for producing the functional film of above Item 1, wherein in the conveyance apparatus, the maximum value of the back pressure at the uncoated surface of the substrate is not less than 10 Pa and not more than 1,000 Pa.

Item 3. The method for producing the functional film of above Item 1 or 2, wherein a length of the substrate between one of the adjacent raised portion and the squared notch is not less than 50 nm and not more than 500 nm, provided that each pair of the adjacent raised portion and squared notch satisfies the condition of the difference of the back pressure being not less than 10 Pa and not more than 1,000 Pa.

Item 4. The method for producing the functional film of any one of Items 1-3, wherein support of the substrate is continued while a concentration of solid components in the coated layer is not more than 80 volume %.

Item 5. The method for producing the functional film of any one of Items 1-4, wherein a ratio of the total areas of each (3) and (4) is from 6:4 to 9:1, wherein (3) is a total area of a surface of the raised portion facing an uncoated surface of the substrate and (4) is a total area of a surface of the squared notch facing to the uncoated surface of the substrate, provided that each pair of the adjacent raised portion and squared notch satisfies the condition of the difference of the back pressure being not less than 10 Pa and not more than 1,000 Pa.

Item 6. The method for producing the functional film of any one of Items 1-5, wherein a distance between an upper surface of the squared notch and the substrate is bigger than that between an upper surface of the raised portion and the substrate by the factor of not less than five, provided that each pair of the adjacent raised portion and squared notch satisfies the condition of the difference of the back pressure being not less than 10 Pa and not more than 1,000 Pa.

Item 7. The method for producing the functional film of any one of Items 1-6, wherein a length of the blowing outlets in a width direction of the substrate is in the range of a width of the substrate ±60 mm, provided that each pair of the adjacent raised portion and squared notch satisfies the condition of the difference of the back pressure being not less than 10 Pa and not more than 1,000 Pa.

Item 8. The method for producing the functional film of any one of Items 1-4, wherein in the conveying apparatus featuring a plurality of raised portions and a plurality of the squared notches, the raised portions are allocated in an arch by a curvature radius of not less than 5 m and not more than 100 m, and the upper surface of the raised portion featuring the blowing outlets to generate the back pressure is almost parallel to the substrate.

Item 9. The method for producing the functional film of any one of Items 1-8, wherein a conveying tension of the substrate in the conveying apparatus is not less than 100 N/m and not more than 600 n/m.

Item 10. The method for producing the functional film of any one of Items 1-9, wherein the substrate conveying in the conveying apparatus is conveyed in a state of arch of a cross-sectional shape perpendicular to the conveying direction with both ends curving down.

Item 11. The method for producing the functional film of any one of Items 1-10, wherein the functional layer is a hard coat layer.

Item 12. The method for producing the functional film of any one of Items 1-11, wherein the substrate contains cellulose triacetate.

Item 13. A conveyance apparatus conveying a belt-like and continuously conveyed substrate onto which (a) a coated layer is formed by coating with a coating solution, and the coating solution containing solid components dissolved or dispersed in a solvent, and (b) the coated layer is dried while the substrate with the coated layer is conveyed by supporting it in a floating state by blowing a gas against an uncoated surface of the substrate from a conveyance apparatus featuring a plurality of blowing outlets arranged along the direction of the conveyance of the substrate in a drying process to produce a functional film by evaporation of the solvent from the coated layer,

wherein the squared notches and raised portions having the blowing outlets are alternately provided, and in a plurality of the adjacent raised portions and the squared notches, the gas is blown from the blowing outlets in order to produce a difference between back pressure (1) and back pressure (2) to be not less than 10 Pa and not more than 1,000 Pa; wherein (1) is the back pressure generated between the raised portion and the uncoated surface of the substrate, and (2) is the back pressure generated between the squared notch, adjacent to the raised portion, and the uncoated surface of the substrate.

Item 14. The conveyance apparatus of Item 13 above, wherein a maximum value of the back pressure at the uncoated surface of the substrate is not less than 10 Pa and not more than 1,000 Pa.

Item 15. The conveyance apparatus of Item 13 or 14 above, wherein a distance of the substrate between one of the adjacent raised portions and the squared notches is not less than 50 nm and not more than 500 nm, provided that each pair of the adjacent raised portion and squared notch satisfies the condition of the difference of the back pressure being not less than 10 Pa and not more than 1,000 Pa.

Item 16. The conveyance apparatus of any one of Items 13-15, wherein a ratio of the total areas of each (3) and (4) being from 6:4 to 9:1, wherein (3) is a total surface area of the raised portions facing an uncoated surface of the substrate and (4) is a total surface area of the squared notch facing the uncoated surface of the substrate, provided that each pair of the adjacent raised portion and squared notch satisfies the condition of the difference of the back pressure being not less than 10 Pa and not more than 1,000 Pa.

Item 17. The conveyance apparatus of any one of Items 13-16, wherein a distance between the upper surface of the squared notches and the substrate is greater than that between an upper surface of the raised portion and the substrate by a factor of not less than five, provided that each pair of the adjacent raised portion and squared notch satisfies the condition of the difference of the back pressure being not less than 10 Pa and not more than 1,000 Pa.

Item 18. The conveyance apparatus of any one of Items 13-17, wherein a length of the blowing outlets in a width direction of the substrate is in the range of a width of the substrate ±60 mm, provided that each pair of the adjacent raised portion and squared notch satisfies the condition of the difference of the back pressure being not less than 10 Pa and not more than 1,000 Pa.

Item 19. The conveyance apparatus of any one of Items 13-18, wherein a shape of this a plurality of raised portions and a plurality of the squared notches, the raised portions are allocated in an arch by a curvature radius of not less than 5 m and not more than 100 m, and the upper surface of the raised portion featuring the blowing outlets to generate the back pressure is almost parallel to the substrate.

Item 20. The conveyance apparatus of any one of Items 13-19, wherein a conveying tension of the substrate is not less than 100 N/m and not more than 600 N/m.

Item 21. A functional film having a hard-coat layer, wherein the functional film is produced with the method for production of any one of Items 1-12.

Item 22. The functional film having an antireflection layer, wherein the functional film is produced with the method for production of any one of Items 1-12.

The foregoing objects of the present invention can be achieved by the following structures, as an embodiment of this invention:

Structure 1. A method for conveying a substrate to obtain a functional film thereon comprising the steps of:

(a) forming a coated layer by coating with a coating solution onto the substrate being belt-like and continuously conveyed, the coating solution containing solid components dissolved or dispersed in a solvent, and

(b) drying the coated layer while the substrate carrying the coated layer is conveyed while supported in a floating state by blowing a gas onto the uncoated surface of the foregoing substrate from a plurality of floating support units having a plurality of blowing outlets arranged in the direction of conveyance of the foregoing substrate in a drying process to produce a functional film by evaporating the solvent from the coated layer,

wherein any back pressure generated by the gas emitted from the foregoing gas outlets against the uncoated surface of the foregoing substrate is in the range of 10-1,000 Pa.

Structure 2. The method for conveying the substrate described in above Structure 1, wherein the maximum value of the foregoing back pressure is 10-1,000 Pa.

Structure 3. The method for conveying the substrate described in above Structure 1 or 2, wherein the interval of increasing and decreasing the foregoing back pressure is at or between 50-500 mm in the direction of conveyance of the foregoing substrate.

Structure 4. The method for conveying the substrate described in any one of Structures 1-3, wherein support of the foregoing substrate by the gas emitted from the foregoing gas blowing outlets continues while the concentration of the solid components in the coated layer does not exceed 80% by volume.

Structure 5. A substrate conveyance apparatus for conveying a substrate by supporting it in a floating state by blowing a gas against the uncoated surface of the foregoing substrate from a plurality of floating support units having a plurality of gas blowing outlets arranged in the direction of conveyance of the foregoing substrate in a drying process to produce a functional film by evaporating the solvent from the coated layer formed by application of a coating solution prepared by dissolving and dispersing a solid in a solvent, to a continuously conveyed belt-like substrate,

wherein a space (being a gap) is provided between the foregoing adjacent floating support units to release the gas emitted from the foregoing outlets, across the width of the foregoing substrate.

Structure 6. The substrate conveyance apparatus described in above Structure 5, wherein the ratio between the overall area of the back pressured of the substrate supported by the foregoing floating support units and the overall area of the back pressured surface not supported is in the range of 6:4-9:1.

Structure 7. The substrate conveyance apparatus described in above Structure 5 or 6, wherein the distance between the installation surface of a floating support unit, serving as a bottom surface of the foregoing space, and the substrate is equal to or greater than 5 times the distance between the upper surface of the floating support unit and the foregoing substrate.

Structure 8. The substrate conveyance apparatus described in any one of foregoing Structures 5-7, wherein the length of the foregoing blow outlets across the width of the substrate is ±60 mm with reference to the width of the substrate.

Structure 9. The substrate conveyance apparatus described in any one of foregoing Structures 5-8, wherein the foregoing floating support units are arranged in an arched configuration having a curvature radius of 5 m or more without exceeding 100 m, and the upper surface of the foregoing floating support units to generate back pressure is located approximately parallel to the substrate.

Structure 10. The substrate conveyance apparatus described in any one of foregoing Structures 5-9, wherein support of the foregoing substrate by the foregoing floating support units is possible to continue while the concentration of the solid components in the coated layer does not exceed 80% by volume.

Structure 11. The substrate conveyance apparatus described in any one of foregoing Structures 5-10, wherein the maximum value of back pressure against the uncoated surface of the substrate by the foregoing floating support units can be adjusted in the range of at or between 10-1,000 Pa.

Structure 12. The substrate conveyance apparatus described in any one of foregoing Structures 5-11, wherein the maximum value of back pressure against the uncoated surface of the substrate by the foregoing floating support units is in the range of at or between 10-1,000 Pa in terms of variation range along the direction of conveyance of the foregoing substrate.

Structure 13. The substrate conveyance apparatus described in any one of foregoing Structures 5-12, wherein the interval of changes in back pressure against the uncoated surface of the substrate by the foregoing floating support unit is 50-500 mm in the direction of conveyance of the foregoing substrate.

Structure 14. A method for drying a coated layer comprising the steps of:

(a) forming a coated layer by coating with a coating solution onto a substrate being belt-like and continuously conveyed, the coating solution containing solid components dissolved or dispersed in a solvent, and

(b) drying the coated layer while the substrate carrying the coated layer is conveyed by being supporting in a floating state by blown gas against an uncoated surface of the foregoing substrate from a plurality of floating support units having a plurality of blowing outlets arranged across the direction of conveyance of the foregoing substrate in a drying process to produce a functional film by evaporating the solvent from the coated layer,

wherein back pressure variation range generated by a gas emitted from the foregoing blowing outlets and the uncoated surface of the foregoing substrate is in the range of 10-1,000 Pa in the direction of conveyance of the foregoing substrate.

Structure 15. The method for drying the coated layer described in above Structure 14, wherein the maximum value of the foregoing back pressure is 10-1,000 Pa.

Structure 16. The method for drying the coated layer described in above Structure 14 or 15, wherein the interval of increasing and decreasing of foregoing back pressure is 50-500 mm in the direction of conveyance of the foregoing substrate.

Structure 17. The method for drying the coated layer described in any one of Structures 14-16, wherein support of the foregoing substrate by the gas emitted from the foregoing blowing outlets is possible to continue while the concentration of the solid in the coated layer does not exceed 80% by volume.

Structure 18. A coated layer drying apparatus to evaporate a solvent in a coated layer while being conveyed by a substrate supported in a floating state by blown gas against the uncoated surface of the substrate from a plurality of floating support units having a plurality of blowing outlets arranged in the direction of conveyance of the substrate in a drying process of the continuously conveyed belt-like substrate to produce a functional film by evaporating the solvent from the coated layer formed by application of a coating solution prepared by dissolving and dispersing solid components in the solvent,

wherein a space is provided between an adjacent floating support units to release a gas emitted from the blow outlets, across the width of the substrate.

Structure 19. The coated layer drying apparatus described in above Structure 18, wherein the ratio between the overall area of a back pressured surface supported by the foregoing floating support units and the overall area of a back pressured surface not supported is in the range of 6:4-9:1.

Structure 20. The coated layer drying apparatus described in Structure 18 or 19, wherein the distance between an installation surface of the floating support units being the bottom surface of the foregoing space, and the substrate is equal to or greater than 5 times the distance between the upper surface of the floating support units and the foregoing substrate.

Structure 21. The coated layer drying apparatus described in any one of Structures 18-20, wherein the length of the foregoing blowing outlets across width of the substrate is ±60 mm with reference to the width of the substrate.

Structure 22. The coated layer drying apparatus described in any one of Structures 18-21, wherein the foregoing floating support units are arranged in an arched configuration having a curvature radius of at or between 5-100 m, and the upper surfaces of the foregoing floating support units to generate back pressure are located approximately parallel to the substrate.

Structure 23. The coated layer drying apparatus described in any one of Structures 18-22 wherein support of the foregoing substrate by the foregoing floating support units is possible to continue while the concentration of the solid components in the coated layer is 80% or less by volume.

Structure 24. The coated layer drying apparatus described in any one of Structures 18-23, wherein the maximum value of back pressure against the uncoated surface of the substrate by the foregoing floating support units can be changed in the range of 10-1,000 Pa.

Structure 25. The coated layer drying apparatus described in any one of Structures 18-24, wherein the maximum value of back pressure against the uncoated surface of the substrate by the foregoing floating support units is in the range of 10-1,000 Pa in terms of the range of variation in the direction of conveyance of the foregoing substrate.

Structure 26. The coated layer drying apparatus described in any one of Structures 18-25, wherein the interval of the changes in back pressure against the uncoated surface of the substrate by the foregoing floating support units is 50-500 mm in the direction of conveyance of the foregoing substrate.

Structure 27. An optical material having a clear hard-coat layer produced according to the conveyance method described in any one of Structures 1-4.

Structure 28. The optical material having the clear hard-coat layer produced by the conveyance apparatus described in any one of Structures 5-13.

Structure 29. The optical material having the clear hard-coat layer produced according to a drying method described in any one of Structures 14-17.

Structure 30. The optical material having the clear hard-coat layer produced by the drying apparatus described in any one of Structures 18-26.

31. The optical material having an antireflection layer produced according to the conveyance method described in any one of Structures 1-4.

Structure 32. The optical material having an antireflection layer produced by the conveyance apparatus described in any one of Structures 5-13.

Structure 33. The optical material having an antireflection layer produced according to the drying method described in any one of Structures 14-17.

Structure 34. The optical material having an antireflection layer produced by the conveyance apparatus described in any one of Structures 18-26.

### EFFECTS OF THE INVENTION

The present invention provides a method for producing a functional film of higher quality at higher productivity, when removing by evaporation a solvent from the coated layer formed by application of a coating solution prepared by dissolving and dispersing solid components in the solvent, to a continuously conveyed belt-like substrate. At the same time, the present invention also provides an apparatus for conveying the foregoing substrate, a coated layer drying method and a drying apparatus for the foregoing procedure, as well as an optical material produced by using these methods and apparatuses. This has facilitated production of a functional film required in the electro-optic panel devices represented the LCD and organic EL where a still higher quality is being requested.

### PREFERABLE EMBODIMENTS OF THIS INVENTION

It should be understood that no single element of any of the embodiments described herein is essential, and that it is within the contemplation of the invention that one or more elements (or method steps) of one or more embodiments of the invention as described herein may be omitted or their functionality may be combined with that of other elements as a general matter of design choice.

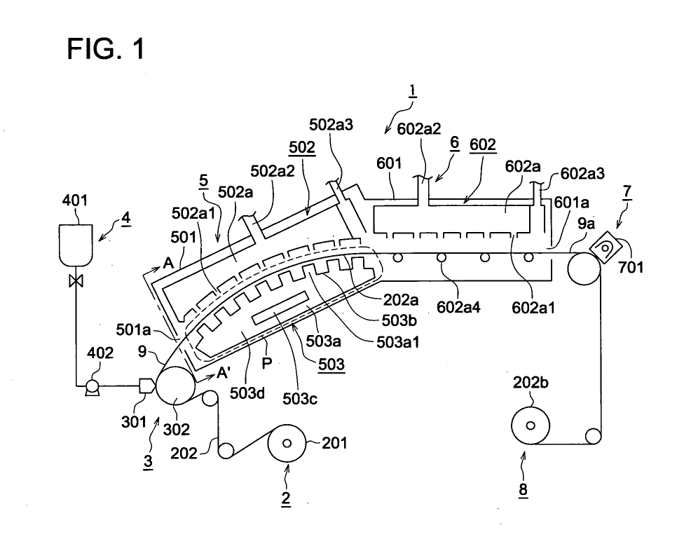

The following describes the embodiments of the present invention with reference to FIG. 1 through FIG. 4 without the present invention being restricted thereto.

A functional film of this invention generally indicates a film formed of a coated surface by coating an appropriate solution onto a belt-like substrate. Examples of such functional films include a silver halide photosensitive material for general public and specific industrial use, a heat-sensitive material, a heat development photosensitive material, a photo-resist, devices of an electro-optic panel represented by an liquid crystal display (being an LCD) and an organic El display.

FIG. 1 is a schematic diagram showing a coating/drying apparatus for removing by evaporation the solvent from the coated layer formed by application of a coating solution on the continuously conveyed belt-like substrate.

In this Figure, “1” denotes a coating/drying apparatus. Coating/drying apparatus 1 includes substrate supply section 2, coating section 3, coating solution supply section 4, first drying section 5, second drying section 6, coated film curing section 7 and recovery section 8. Substrate supply section 2 supplies roll-shaped substrate 201 wound on a core.

Coating section 3 contains: coater 301 for applying a coating solution prepared by dissolving and dispersing solid components in a solvent, to belt-like substrate 202 which is unwound from substrate supply section 2 and is continuously conveyed; and backup roll 302 for supporting belt-like substrate 202. There is no restriction to the type of coater 301 to be used. For example, it can be a sliding type die coater, extrusion type die coater, curtain die coater, curtain spray type die coater, gravure coater, wire bar coater, dip coater, reverse roll coater and inkjet. Any one of them can be selected for use according to the particular requirement. This Figure shows the extrusion type die coater for the present explanation.

Coating solution supply section 4 includes solution feed tank 401 for storing the coating solution prepared by dissolving and dispersing solid components in a solvent, and solution feed pump 402 for feeding the coating solution to coater 301.

First drying section 5 contains first drying apparatus 501 and first drying air blowing apparatus 502 accommodated in first drying apparatus 501, and conveyance apparatus 503. The reference numeral 501a indicates an inlet of substrate 202 arranged on first drying apparatus 501. In first drying section 5, belt-like substrate 202 wherein coated film 9 is formed by application of the coating solution on belt-like substrate 202 by coater 301 of coating section 3 is supported in a floating state by conveyance apparatus 503. While the concentration of the solid components in coated film 9 does not exceed 80%, the film is conveyed and dried by first drying section 5. In this case, the solid component concentration of 80% can be defined as follows: For example, the solid component concentration is 50% by volume at the time of preparing the coating solution. Subsequent to coating, the solid component concentration in terms of volume is increased by removal of the solvent from the coated layer by evaporation thereby reaching to reach the level of 80% by volume.

First drying air blowing apparatus 502 is provided with first gas (dry air) header 502a as blowing means having a plurality of blowing outlets 502a1 for blowing gas (dry air) to coated film 9. The reference numeral 502a2 denotes a dry air supply tube for supply dry air to first gas (dry air) header 502a, and 502a3 indicates an exhaust outlet for gas (dry air). The number of blowing outlets 502a1 changes according to the type of the coated layer, and can be determined as required. It should be noted that no restriction is imposed on the method of drying. For example, a heating method using a heater or blowing dry air can be mentioned. Any method can be adopted to meet a particular requirement. In this figure, a dry air blowing apparatus is used for heating. At least the raised portions feature the blowing outlets as shown in the figure, however the squared notches may or may not feature the blowing outlets.

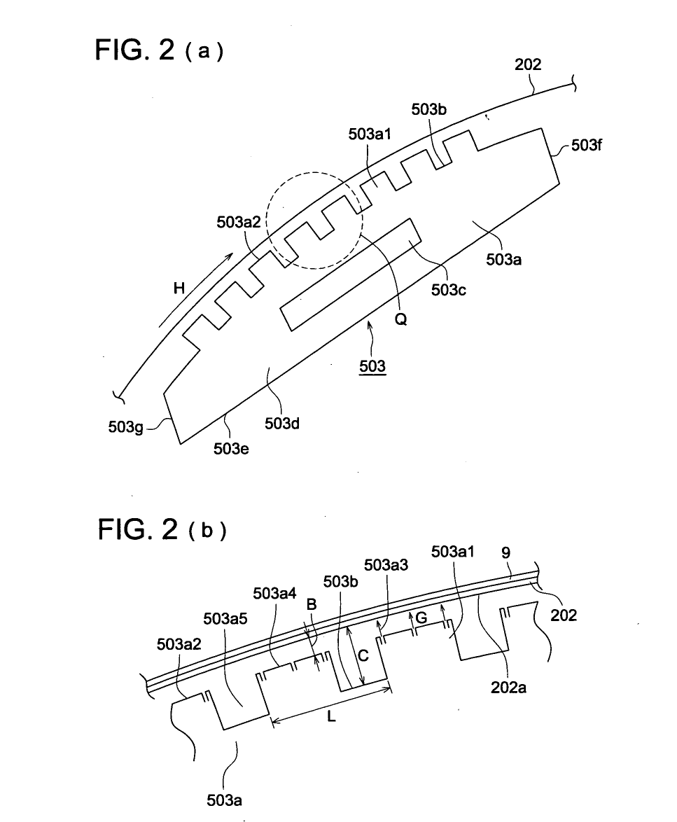

Conveyance apparatus 503 includes floating gas header 503a as a floating support means wherein a plurality of floating support units 503a1 are provided along the direction of conveyance of substrate 202, wherein these floating support units 503a1 contains a plurality of blowing outlets 503a3, being raised portions (please refer to FIG. 2) for blowing gas onto the side of uncoated surface 202a of substrate 202. The uncoated surface is defined as a surface opposite the surface coated with coated film 9 of substrate 202.

Floating support units 503a1 are mounted on installation surface 503b of floating gas header 503a. The reference numeral 503c indicates a gas inlet arranged on lateral surface 503d of floating gas header 503a. This Figure does not illustrate the gas supply tube leading to floating gas header 503a, and exhaust tube. Conveyance apparatus 503 will be described in details with reference to FIG. 2 through FIG. 4.

In conveyance apparatus 503, substrate 202 is supported in a floating state by pressurized gas against the uncoated surface from blowing outlets 503a3 (please refer to FIG. 2) of floating gas header 503a. Floating support of the film by the floating support means preferably continues until the solid concentration in the coated layer is reduced 80% or less by volume. In first drying section 5, in contrast to the temperature of the forced gas blown against the uncoated surface from blowing outlets 503a3 (FIG. 2), the dry air temperature is preferably at or between 10-100° C., because it is essential to promote drying of the coated surface while minimizing any adverse effects of heat to the substrate. Support of the substrate by the emitted gas from the gas blowing outlets is preferably continued from immediately after coating and through the period that the solid content in the coated layer is less than 80% by volume, however, it is also preferable that the substrate is physically conveyed for a while after coating and then supported by the forced gas means. The solid content in the coated layer while conveyed in the floating state (being % by volume) may be determined with the coating conditions using simulation software.

Second drying section 6 is equipped with second drying apparatus 601 and second drying air blowing apparatus 602 accommodated in second drying apparatus 601. In second drying section 6, the remaining solvent is further removed from coated film 9 of substrate 202 wherein the solid component concentration in coated film 9 is reduced to the level not exceeding 80% by first drying section 5. Functional film 9a is dried until the solvent is virtually completely removed from coated film 9 when coming out of second drying section 6.

Second drying air blowing apparatus 602 has second gas (dry air) header 602a as second blowing means provided with a plurality of blowing outlets 602a1 for blowing gas (dry air) to coated film 9 of substrate 202. The reference numeral 602a2 indicates a dry air supply tube for supplying dry air to second gas (dry air) header 602a. The reference numeral 602a3 represents a gas (dry air) exhaust outlet.

The number of blowing outlets 602a1 varies according to the type of the coated layer. They can be provided as required. The numeral 602a4 indicates a conveyance roll for conveying substrate 202 by supporting the rear surface (uncoated surface) of substrate 202 in contact therewith. The reference numeral 601a is an outlet of second drying apparatus 601. It should be noted that no restriction is imposed on the method of drying. For example, a heating method using a heater or blowing dry air can be mentioned. Any method can be adopted to meet a particular requirement. In this Figure, a dry air blowing apparatus is used for heating.

When a radiation curable material is used as the coated layer, the solvent is removed from the coated layer by evaporation and the film is dried. After that, the coated layer is subjected to the process of curing. This procedure provides the intended functional film.

Coated film curing section 7 shows curing unit 701 arranged to cure functional film 9a formed by second drying section. There is no restriction to the position of coated film curing section 7. It can be installed at any position after the drying point. For example, coated film curing section 7 can be installed inside or outside second drying apparatus 601. In this Figure, it is located outside second drying apparatus 601. For example, any one of the following lamps can be used as curing unit 701, such as a low-voltage mercury lamp, an intermediate voltage mercury lamp, a high-voltage mercury lamp, an extra high-voltage mercury lamp, a carbon arc lamp, a metal halide lamp, or a xenon lamp, although it depends on the type of functional film 9a. The conditions of irradiation differ according to a lamp, but the intensity of light can be set as required in response to the type of functional film 9a.

In recovery section 8, substrate 202 containing functional film 9a treated by coated film curing section 7 is wound on the core, and is recovered as roll-shaped substrate 202b. It is preferred to cool substrate 202 wherein functional film 9a is formed before being wound on the core (e.g., down to the room temperature).

Through concentrated study efforts, the present inventors have made efforts to find out the following: When the solvent is removed from coated film 9 by evaporation by coating/drying apparatus 1, coated film 9 in first drying section 5 is in the stage of fluidity in the initial stage of drying, and a trouble is likely to occur to the coated layer while fluidity is maintained. A trouble is most likely to occur the coated layer especially in the area wherein the concentration of solid in the coated layer does not exceed 80% by volume, according to the finding of the present inventors.

In this area, if deformation of substrate 202 (stretch along the direction of conveyance), or the flapping of substrate 202 resulting from unstable floating support has occurred, even if coated film 9 coated on substrate 202 is formed temporarily on the substrate at the time of coating, the coated surface is made to conform to the deformation of substrate 202 by the leveling due to the gravity or surface tension. If the film is dried and solidified in this state, the thickness of the functional film will be different in substrate 202. This will result in variations in the thickness of the coated layer. Further, the gas blown to the uncoated surface (rear) from blowing outlets 503a3 (FIG. 2) of a plurality of floating support units 503a1 of conveyance apparatus 503 in first drying apparatus 501 spreads over to the surface of coated film 9, the film surface is disturbed, and a variation occurs to the thickness of the coated layer.

The present invention provides a method for conveying the substrate equipped with coated film for getting the coated layer of uniform thickness wherein the first drying section shown in this Figure is used to dry the coated layer of the substrate containing the coated layer whose concentration of solid does not exceed 80% by volume, and possible disturbance of the coated surface is avoided. At the same time, the present invention also provides a conveyance apparatus, drying method and drying apparatus for this procedure.

FIG. 2 is an enlarged schematic diagram of the conveyance apparatus of FIG. 1. FIG. 2(a) is an enlarged schematic diagram representing the portion P of FIG. 1. FIG. 2(b) is an enlarged schematic diagram representing the portion Q of FIG. 2(a).

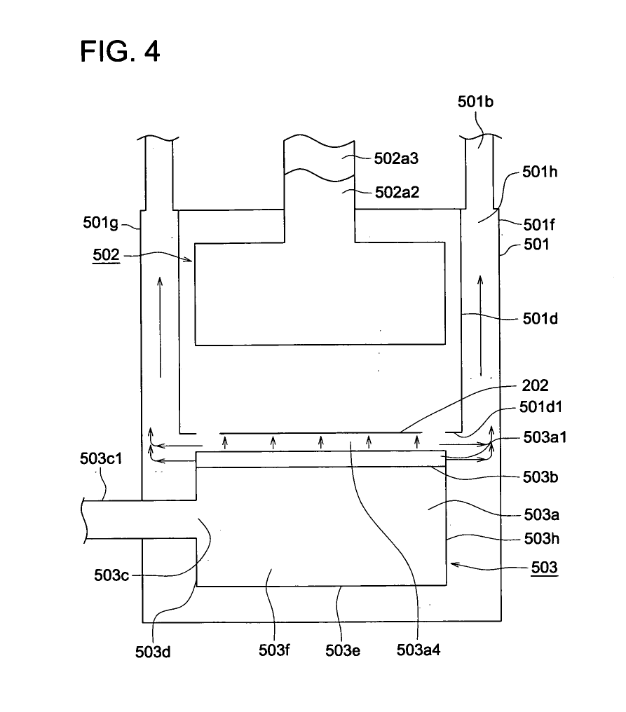

In the Figure, 503e is a bottom surface of floating gas header 503a. 503f is a lateral surface on the short side, and 503g a lateral surface on the other short side. Floating gas header 503a is designed in a box structure containing arch-shaped surface 503b provided with a plurality of floating support units 503a1, lateral surface 503d equipped with gas inlet 503c, lateral surface 503h (FIG. 4), bottom surface 503e and lateral surface 503f (503g). The gas supplied from gas inlet 503c is emitted from blowing outlets 503a3 of floating support unit 503a1 to substrate 202 in a floating state and to adjust the temperature of substrate 202. “Between the raised portion and the uncoated surface of the substrate” means “between the upper surface of floating support unit 503a1 and the uncoated surface of the substrate indicated by 202”. Further, “between the squared notch adjacent to the raised portion and the uncoated surface of the substrate” means “between the space such as 503a5 and the uncoated surface of the substrate”, in another expression, “between the installation surface such as 503b and 202a”.

In this figure, of uncoated surface 202a of substrate 202 arranged face to face with floating gas header 503a, the surface arranged face to face with upper surface 503a2 of floating support unit 503a1 is supported by floating support units 503a1. This surface is referred to as a back pressure surface. The surface not supported by floating support unit 503a1 (the surface not in face to face with upper surface 503a2 of floating support unit 503a1) is referred to as a non-back pressure surface.

Arrow mark H indicates the direction of conveyance of substrate 202, when conveyed in that direction, back pressure varies due to the gas against uncoated surface 202a is at or between 10-1,000 Pa along the direction of conveyance. If the variation of back pressure is below 10 Pa, the width of the escape route is reduced. If enough back pressure required for floatation is provided, the speed of the gas escaping from the gap is increased and the gas will tend to spread up and over to the surface of the coated layer. Consequently, the substrate flutters, with the result that the still liquid coated layer is disturbed, which is of course not acceptable. On the contrary if the variation of back pressure exceeds 1,000 Pa, the escape route will become too broad, and the back pressure effect will be insufficient to float the substrate, so that stable floating support cannot be ensured. Obviously when the substrate flutters, the coated layer is disturbed, which must be avoided. The back pressure between the raised portion and the uncoated surface of the substrate is static pressure, measured as follows. A SUS-made pipe, (SUS is Steel Use Stainless), exhibiting a diameter of 1 mm and an inner diameter of 0.5 mm wherein the tip of the pipe ends in an opening is inserted between floating support unit 503a1 and substrate 202. The tip reaches to almost the center of the width of the substrate, so that the upper surface of the floating support unit contacts the tip of the pipe [at a position away from the rear surface of the substrate by distance B given in FIG. 2(b)]. Then Manostar Gauge WO81, manufactured by Chiyoda Sokutei Kogyo Co., Ltd., is connected to this pipe, whereby the static pressure, being the back pressure, is measured. Where the film is not supported by the floating support unit, that is, the space between the floating support units (being the squared notch), the back pressure between the squared notch and the uncoated surface of the substrate is measured as follows. In the center of the width of the substrate, the tip of the same SUS pipe is arranged to almost reach the rear surface of the substrate by distance B given in FIG. 2(b), whereby static pressure is measured, and further whereby any change in the back pressure along the direction of conveyance is measured. In the raised portions and the squared notches satisfying the condition of the back pressure difference being more than 10 Pa and less than 1,000 Pa, the maximum back pressure of the uncoated surface of the substrate above the raised portions is preferably between 10-1,000 Pa. Further, in FIG. 2(a), arrow L is a length between one of the adjacent raised portions and the squared notches, and it means the length is a width of the raised portion and squared notch.

When considering the amount of floatation of the substrate, based on a balance of back pressure, the tension, along the direction of conveyance of substrate 202, is preferably at or between 100-400 N/m. In this case, the tension is a value obtained by conversion of the force applied to the tension pickup roll mounted in the conveyance line. Further, the conveying tension is more preferably 150-350 N/m, and specifically in the case which the substrate is a cellulose ester film, the conveying tension is preferably in the range of 150-350 N/m.

At the time of conveyance in the direction of conveyance, if the range of variation of the back pressure caused by the gas on the uncoated surface is kept at or between 10 and 1,000 Pa along the direction of the conveyance, the following advantages are provided. (1) The substrate can be conveyed on stable floating support to minimize the disturbance of newly coated film due to fluttering. This arrangement provides a functional film of uniform film thickness free from irregularity due to disturbance. (2) Pressure is applied to the substrate to release the stretch. This arrangement avoids uneven thickness of the coated layer caused by inherent leveling, and provides a functional film of uniform film thickness free from irregularity or effects of forced gas disturbance. Further, when the conveying apparatus is viewed from its edge, it is preferable that a line, connecting the center points of the upper surfaces of the raised portions, depicts an arch shape of the curvature radius of more than 5 m and less than 100 m. Further, the difference between the highest point and the lowest point of the arch shape is preferably 1-20 mm.

Reference numeral 503a2 shows the upper surface of floating support unit 503a1. Floating support unit 503a1 is structured on arched surface 503b of floating gas header 503a. Unit 503a1 is formed parallel to conveyance of the substrate 202. The curvature radius of the plurality of floating support units 503a1 arranged in the arched form is preferably at or between 5 and 100 m, with consideration given to equilibrium between back pressure and tension, conveyance stability and strength of the substrate. In this case, the curvature radius is the value obtained from the coordinates at the top surface of floating support unit 503a1. Further, “a total area of a surface of the raised portion facing an uncoated surface of the substrate” means “a total area of a surface of the raised portion (such as 503a2 in FIG. 2) facing an uncoated surface of the substrate (designated by 2022)”. And “a total area of a surface of the squared notch facing the uncoated surface of the substrate” means “a total area of a surface of the squared notch (such as the area of 503b) facing the uncoated surface of the substrate (designated by 202a)”.

When the curvature radius is kept within the range from 5 m or more without exceeding 100 m, the following advantages are provided: (1) Stability in floating and conveyance and correction of stretch of the substrate are achieved in perfect balance. This arrangement provides a functional film of uniform film thickness free from irregularity or disturbance.

Reference numeral 503a4 shows a gap formed between upper surface 503a2 of the floating support units and the uncoated surface floated by the gas emitted from blowing outlets 503a. 503a5 denotes a gap formed by installation surface 503b of floating support units 503a1 and the uncoated surface floated by the gas emitted from blowing outlets 503a. Symbol B indicates the distance (being the amount of floatation) of gap 503a4, while “C” indicates the distance of gaps 503a5. Distance B (being the amount of floatation) is preferably at or between 3-50 mm, with consideration given to deformation of the substrate especially on both edges, fluttering of the substrate, velocity of the air blown, spreading of the blown air onto the coated layer, tension of the substrate and the back pressure. In cases when the cross-section, being perpendicular to the conveyance direction of the substrate is in the shape of an arch, the edges of which curve down, distance B is the distance between the edges of the substrate and the edges of the floating support units.

Giving consideration to fluttering of the substrate, the amount of the blown air and back pressure, the distance C is preferably equal to or greater than five times distance B, but is no more than 100 times. In this case, the distance B (being the amount of floatation) and distance C can be measured directly across the width using a common measuring tool.

If distance C is equal to or greater than five times distance B, the following advantages are gained: (1) Vibration of the belt-like coated substrate, formed of a coated layer, by the exhaust gas is largely eliminated and conveyance of stable floating-support is enabled. This arrangement provides a coated layer of uniform film thickness free from irregularity and coated surface disturbance.

The back pressure against the uncoated surface is increased in gap 503a4, while it is decreased in gap 503a5. The interval from increase in the back pressure to the decrease is preferably at or between 50-500 mm along the direction of the conveyance of the coated substrate with consideration given to the apparatus manufacturing cost, fluttering of the substrate, and gas emission from the gas outlets.

If the interval between increase and decrease in back pressure is kept in the range of at or between 50-500 mm along the direction of the conveyance of the coated substrate, the following advantages are realized: (1) Conveyance of stable floating-support is ensured, which provides a coated layer of uniform thickness free from irregularity or coated surface disturbance.

In gap 503a4, the maximum back pressure applied to the uncoated surface is preferably at or between 10-1,000 Pa, with consideration given to contact with the floating support unit due to deformation of the substrate especially on both ends, fluttering of the substrate, and spreading of the excess air blown over the still liquid coated layer solution.

If the maximum back pressure applied to the uncoated surface is at or between 10-1,000 Pa, the following advantages are provided: (1) Conveyance of stable floating support is ensured, which provides a coated layer of uniform thickness free from irregularity due to disturbance.

Arrow G indicates the direction of supporting gas emitted from blow outlets 503a3 of floating support units 503a1. Gas is preferably emitted in the direction with reference to the uncoated surface by considering stable parallelity between the back surface and the uncoated surface, and floating stability along the direction of the conveyance of substrate 202.

The gas emitted from blowing outlets 503a3 flows along the width of the substrate within gap 503a4 and gap 503a5 and is discharged from exhaust outlet 501b (please refer to FIG. 4).

Substrate 202 is float-supported by the gas emitted from blowing outlets 503a3 of floating support unit 503a1, and is dried while being conveyed in the direction of conveyance indicated by arrow H in FIG. 2(a). The velocity of the emitted gas from blowing outlets 503a3 is preferably at or between 5-20 m/s, considering deformation and vibration of the substrate as well as floatation stability. The gas velocity is determined as a value measured by a hot-wire anemometer.

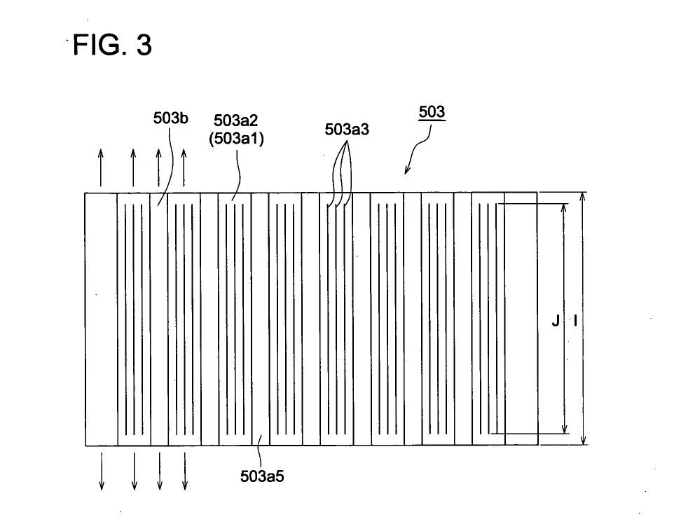

FIG. 3 is a schematic expansion plan of the conveyance apparatus of FIG. 1.

In the figure, I indicates the width of upper surface 503a2 of floating support units 503a1, and J represents the width of the blowing outlets 503a3. Width variation of J is preferably within ±60 mm, with consideration given to floatation, and flatness at the edges of substrate 202 (please refer to FIG. 1) with reference to the width of the substrate 202 (FIG. 1) and the spread of the gas emitted from the blowing outlets 503a3 of floating support unit 503a1 over the film surface. In the figure, the arrow indicates the direction in which the gas emitted from blowing outlets 503a3 flows from gap 503a4 and gap 503a5 across the width of the substrate, after having been faced colliding against the uncoated surface of the substrate. Other reference numerals are the same as those of FIG. 2. In cases when the cross-sectional shape, perpendicular to the conveying direction of conveying substrate, is an arch, the distances are those between the edges of the substrate and the upper surfaces of the squared notches and the raised portions.

When the width of blowing outlets 503a3 is kept within 60 mm with regard to the width of substrate 202 (please refer to FIG. 1), the following advantages are provided: (1) Stable conveyance of floating film support is ensured. This provides a coated layer of uniform film thickness free from irregularity due to forced gas disturbance.

When considering the temperature control of substrate 202, vibration control and size of the conveyance apparatus, the ratio between the overall area of the back pressure surface wherein substrate 202 is supported by the floating support unit (being the total, when supported by eight floating support units in this figure) and the overall area of the non-back pressured surface, wherein substrate 202 is not supported by the floating support units is preferably 6:4-9:1. In the present invention, the areas of the back pressured surface and non-back pressured surface are determined as follows:

Overall area of back pressured surface: length of the upper surface of one floating support unit along the direction of the conveyance times the width of substrate times the number of floating units

Overall area of non-back pressured surface: length along the direction of conveyance between the floating units adjacent to each other along the direction of conveyance times the width of substrate times the number of space between floating units. When the ratio between the overall area of the back pressured surface and that of the non-back pressured surface is 6:4-9:1, the following advantages are gained:

(1) Stable conveyance of floating-support is ensured. This provides a coated layer of uniform thickness free of irregularities or disturbance.

FIG. 4 is a schematic cross sectional view taken along arrow line AA′ of FIG. 1.

In the Figure, 503c1 denotes a tube for supply of gas to the floating gas header 503a, and 501b shows a gas exhaust tube for the gas coming from the blow outlet 503a3 (FIG. 2) of the floating support unit 503a1 of the floating gas header 503a.

The reference numeral 501d is a wind shield for ensuring that the gas coming from the blow outlet 503a3 (FIG. 2) does not spread over to the surface of the coated layer 9. It is preferably installed outside the lateral surface 503h of the floating gas header 503a. The front end 501d1 is bent in the form of a letter L close to the crosswise end of the float-supported substrate 202 without coming into contact therewith.

After having collided the uncoated surface (rear surface) of the substrate 202, the gas emitted from the blow outlet 503a3 (FIG. 3) by the wind shield 501d is discharged across the width from the gap 503a4 and gap 503a5 (FIG. 2), and is discharged through the gap 501h between the wind shield 501d and the side wall 501f of the first drying apparatus 501 through the exhaust tube 501b. The arrow of the Figure indicates the flow of gas. The same wind shield as the wind shield 501d is arranged opposite the floating gas header 503a so that the gas from the blow outlet 503a3 (FIG. 3) can be discharged. Other reference numerals are the same as those of FIG. 1 and FIG. 2.

There is no restriction to the material containing the functional layer produced by the coating/drying apparatus shown in FIG. 1 through FIG. 4. For example, it is possible to use the optical materials which are used in the devices of an electro-optic panel represented by a silver halide photosensitive material for general and industrial use, heat-sensitive agent, heat development photosensitive material, photo-resist, LCD and organic EL. Particularly, it is preferably to be used to produce the optical materials having the functional layers which are used in the devices of an electro-optic panel represented by the LCD and organic EL wherein high performances are required.

No restriction is imposed on the material of the belt-like coated member of the present invention. For example, it is possible to use a polyester film such as a cellulose ester-based film, polyester-based film, polycarbonate-based film, polyarylate-based film, polysulfone (also including polyether sulfone)-based film, polyethylene terephthalate and polyethylene naphthalate, as well as a polyethylene film, polypropylene film, cellophane, cellulose diacetate film, cellulose triacetate, cellulose acetate butylate film, polyvinylidene chloride film, polyvinyl alcohol film, ethylene vinyl alcohol film, syndiotactic polystyrene-based film, polycarbonate film, cyclo olefin polymer film (Arton (by JSR), Zeonex and Zeonea (by Nippon Zeon Co., Ltd.), polymethyl pentene film, polyether ketone film, polyether ketone imide film, polyamide film, fluorine resin film, nylon film, polymethyl methacrylate film, acryl film. These films can be produced by either melt extrusion or casting film manufacturing method. The material can be selected as appropriate in conformity to the product to be produced.

Of these materials, the cellulose ester is preferably used as an optical material because of its excellent transparency, heat resistance, and compatibility with liquid crystals, as well as lower inherent double refractive index and lower photoelastic coefficient. Further, flatness and smoothness of triacetyl cellulose film (being a TAC film) is usually inferior to polyethylene terephthalate film (being a PET film). However, in this invention, the targeted effects appear notably in TAC film. Therefore it is preferable to apply this invention to TAC film.

The cellulose ester of the present invention is an independent or mixed acid ester containing any one of the fatty acid acyl groups, as well as substituted and unsubstituted aromatic acyl groups. In the aromatic acyl group when the aromatic ring is a benzene ring, the substituent of the benzene ring is exemplified by halogen atom, cyano, alkyl group, alkoxy group, aryl group, aryloxy group, acyl group, carbon amide group, sulfone amide group, ureide group, aralkyl group, nitro, alkoxy carbonyl group, aryloxy carbonyl group, aralkyloxy carbonyl group, carbamoyl group, sulfamoil group, acyloxy group, alkenyl group, alkynyl group, alkyl sulfonyl group, aryl sulfonyl group, alkyloxy sulfonyl group, aryloxy sulfonyl group, alkyl sulfonyloxy group, aryloxy sulfonyl group, —S—R, —NH—CO—OR, —PH—R, —P(—R)₂, —PH—O—R, —P(—R) (—O—R), —P(—O—R)₂, —PH(═O)—R—P(═O) (—R)₂, —PH(═O)—O—R, —P(═O) (—R) (—O—R), —P(═O) (—O—R)₂, —O—PH(═O)—R, —O—P(═O) (—R)₂—O—PH(═O)—O—R, —O—P(═O) (—R) (—O—R), —O—P(═O) (—O—R)₂, —NH—PH(═O)—R, —NH—P(═O) (—R) (—O—R), —NH—P(═O) (—O—R)₂, —SiH₂—R, —SiH(—R)₂, —Si(—R) 3, —O—SiH₂—R, —O—SiH(—R)₂ and —O—Si(—R)₃. The foregoing R indicates an aliphatic group, aromatic group or hetero ring group. The number of the substituents is preferably 1-5, more preferably 1-4, still more preferably 1-3, but most preferably 1 or 2. The substituent is preferably a halogen atom, a cyano group, an alkyl group, an alkoxy group, an aryl group, an aryloxy group, an acyl group, a carbon amide group, a sulfone amide group and an ureide group, more preferably a halogen atom, a cyano group, an alkyl group, an alkoxy group, an aryloxy group, an acyl group and a carbon amide group, still more preferably a halogen atom, a cyano group, an alkyl group, an alkoxy group and an aryloxy group, most preferably a halogen atom, an alkyl group and an alkoxy group.

The above halogen atom contains a fluorine atom, a chlorine atom, a bromine atom and an iodine atom. The above alkyl group may have a ringed or a branched structure. The number of carbon atoms in the alkyl group is preferably 1-20, more preferably 1-12, still more preferably 1-6, but most preferably 1-4. The alkyl group is exemplified by methyl, ethyl, propyl, isopropyl, butyl, t-butyl, hexyl, cyclohexyl, octyl and 2-ethylhexyl. The above alkoxy group may include a ringed or a branched structure. The number of carbon atoms in the alkoxy group is preferably 1-20, more preferably 1-12, still more preferably 1-6, but most preferably 1-4. The alkoxy group can be substituted by another alkoxy group, which is exemplified by methoxy, ethoxy, 2-methoxyethoxy, 2-methoxy-2-ethoxyethoxy, butyloxy, hexyloxy and octyloxy.

The number of carbon atoms in the foregoing aryl group is preferably 6 through 20, more preferably 6 through 12. The aryl group is exemplified by phenyl and naphthyl. The number of carbon atoms in the foregoing aryloxy group is preferably 6 through 20, more preferably 6 through 12. The aryloxy group is exemplified by phenoxy and naphtoxy. The number of carbon atoms in the foregoing acyl group is preferably 1 through 20, more preferably 1 through 12. The acyl group is exemplified by formyl, acetyl and benzoyl. The number of carbon atoms in the foregoing carbon amide group is preferably 1 through 20, more preferably 1 through 12. The carbon amide group is exemplified by acetoamide and benzamide. The number of carbon atoms of the foregoing sulfone amide group is preferably 1 through 20, more preferably 1 through 12. The sulfone amide group is exemplified by methane sulfone amide, benzene sulfone amide and p-toluenesulfone amide. The number of carbon atoms of the foregoing ureide group is preferably 1 through 20, more preferably 1 through 12. The ureide group is exemplified by (unsubstituted) ureide.

The number of carbon atoms of the foregoing aralkyl group is preferably 7 through 20, more preferably 7 through 12. The aralkyl group is exemplified by benzyl, phenethyl and naphthyl methyl. The number of carbon atoms of the foregoing alkoxy carbonyl group is preferably 1 through 20, more preferably 2 through 12. The alkoxy carbonyl group is exemplified by methoxy carbonyl. The number of carbon atoms of the foregoing aryloxy carbonyl group is preferably 7 through 20, more preferably 7 through 12. The aryloxy carbonyl group is exemplified by phenoxy carbonyl. The number of carbon atoms of the foregoing aralkyloxy carbonyl group is preferably 8 through 20, more preferably 8 through 12. The aralkyloxy carbonyl group is exemplified by benzyloxy carbonyl. The number of carbon atoms of the foregoing carbamoyl group is preferably 1 through 20, more preferably 1 through 12. The carbamoyl group is exemplified by (unsubstituted) carbamoyl and N-methyl carbamoyl. The number of carbon atoms of the foregoing sulfamoyl group is preferably 20 or less, more preferably 12 or less. The sulfamoyl group is exemplified by (unsubstituted) sulfamoyl and N-methyl sulfamoyl. The number of carbon atoms of the foregoing acyloxy group is preferably 1 through 20, more preferably 2 through 12. The acyloxy group is exemplified by acetoxy and benzoyloxy.

The number of carbon atoms of the foregoing alkenyl group is preferably 2 through 20, more preferably 2 through 12. The alkenyl group is exemplified by vinyl, alyl and isopropenyl. The number of carbon atoms of the foregoing alkynyl group is preferably 2 through 20, more preferably 2 through 12. The alkynyl group is exemplified by thienyl. The number of carbon atoms of the foregoing alkyl sulfonyl group is preferably 1 through 20, more preferably 1 through 12. The number of carbon atoms of the foregoing aryl sulfonyl group is preferably 6 through 20, more preferably 6 through 12. The number of carbon atoms of the foregoing alkyloxy sulfonyl group is preferably 1 through 20, more preferably 1 through 12. The foregoing aryloxy sulfonyl group is preferably 6 through 20, more preferably 6 through 12. The number of carbon atoms of the foregoing alkyl sulfonyloxy group is preferably 1 through 20, more preferably 1 through 12. The number of carbon atoms of the foregoing aryloxy sulfonyl group is preferably 6 through 20, more preferably 6 through 12.

In the cellulose ester of the present invention, when the hydrogen atom of the hydroxyl group of the cellulose is a fatty acid ester with the aliphatic acyl group, the aliphatic acyl group has 2 through 20 carbon atoms. To put it more specifically, it is exemplified by acetyl, propyonyl, butylyl, isobutylyl, valeryl, pivaloyl, hexanoyl, octanoyl, lauroyl and stearoyl.

In the present invention, the foregoing aliphatic acyl group further includes the group containing a substituent. When the aromatic ring is a benzene ring in the foregoing aromatic acyl group, the one exemplified as the substituent of the benzene ring can be mentioned as the substituent.

When the esterified substituent of the foregoing cellulose ester is an aromatic ring, the number of the substituents X to replace the aromatic ring is 0 or 1 through 5, preferably 1 through 3, more preferably 1 or 2. Further, the number of the substituents to replace the aromatic ring is two or more, they may be the same or different from each other, or may be combined with each other to form a condensed polycyclic compound (e.g. naphthalene, indene, indan, phenanthrene, quinoline, isoquinoline, chromene, chroman, phthalazine, acridine, indole, and indoline).

In the foregoing cellulose ester, the structure wherein at least one of the substituted and unsubstituted aliphatic acyl groups, and substituted and unsubstituted aromatic acyl groups is selected is the structure used in the cellulose ester of the present invention. They can be an independent cellulose ester or mixed acid ester, or a mixture of two or more cellulose esters.

The cellulose ester of the present invention is preferably one of the cellulose acetate, cellulose propionate, cellulose butylate, cellulose acetate propionate, cellulose acetate butylate, cellulose acetate phthalate and cellulose phthalate.

For the replacement ratio of the mixed fatty acid ester, a lower fatty acid ester of the cellulose acetate propionate and cellulose acetate butylate contains an acyl group of 2 through 4 carbon atoms as a substituent. Assuming that the acetyl group replacement ratio is X and propionyl group or butyryl group replacement ratio is Y, this cellulose resin contains the cellulose ester meeting both the following formulae (I) and (II):
2.6≦X+Y≦3.0 Formula (I)
0≦X≦2.5 Formula (II)

Of these, cellulose acetate propionate is preferably used. It is particularly preferred that the replacement ratio be 1.9≦X≦2.5 and 0.1≦Y≦0.9. The unsubstituted portion of the foregoing acyl group is normally a hydroxyl group, which can be synthesized by the commonly known method.

In the cellulose ester used in the present invention, the ratio between weight average molecular weight Mw and number average molecular weight Mn is preferably 1.5 through 5.5, more preferably 2.0 through 5.0, still more preferably 2.5 through 5.0, further more preferably 3.0 through 5.0.

The material cellulose of cellulose ester used in the present invention can be either a wood pulp or a cotton linter. The wood pulp can be either a conifer or a broad-leaved tree. The conifer is more preferably used. From the viewpoint of separability at the time of film formation, the cotton linter is preferably used. The cellulose ester made of such a material can be mixed as appropriate for use, or can be used independently.

For example, it is possible to use at the ratio of the cotton linter-derived cellulose ester to wood pulp (conifer)-derived cellulose ester to wood pulp (broad-leaved tree)-derived cellulose ester is 1,000:0, 90:10:0, 85:15:0, 50:50:0, 20:80:0, 10:90:0, 0:1,000, 0:0:100, 80:10:10, 85:0:15, or 40:30:30.

The coating solution of the present invention preferably contains 0.5 through 20 percent by mass of high molecular component. The high molecular component is exemplified by gelatine, methyl cellulose, carboxy methyl cellulose, polyacrylic acid, polyvinyl ether, polyvinyl alcohol, polyvinyl pyrrolidone and natural rubber.

No restriction is imposed on the coating solution containing the foregoing high molecular component. For example, the solution for coating the devices of an electro-optic panel represented by a silver halide photosensitive material for general and industrial use, heat-sensitive agent, heat development photosensitive material, photo-resist, LCD and organic EL can be mentioned. A device for electro-optic panel can be exemplified by the optical material provided with an antireflection layer to be bonded to the front surface of the display apparatus in order to improve the visibility of the CRT and liquid crystal display apparatus. A display apparatus having a large screen as the TV set may come into contact with foreign substances and may be scratched. To prevent it from being scratched, the optical material with a clear hard-coat layer formed on the substrate or the optical material with an antireflection layer formed thereon is normally used. The following describes the optical material with a clear hard-coat layer formed on the substrate or the optical material with an antireflection layer formed thereon.

The following describes the optical material provided with a clear hard-coat layer. An actinic radiation curable resin layer is preferably used as a clear hard-coat layer. The actinic radiation curable resin layer is defined as the layer mainly composed of a resin that is cured through the reaction of crosslinking by exposure to actinic radiation such as an ultraviolet ray and electron beam. A component containing a monomer of ethylenic unsaturated double bond is preferably used as the actinic radiation curable resin. It is cured by exposure to the actinic radiation such as an ultraviolet ray or electron beam and is formed into a hard-coat layer. The actinic radiation curable resin is typically represented by ultraviolet ray curable resin or electron beam curable resin. The resin cured by exposure to the ultraviolet ray is preferably used.

The preferably used ultraviolet ray curable resin is exemplified by an ultraviolet curable type urethane acrylate-based resin, ultraviolet curable type polyester acrylate-based resin, ultraviolet curable type epoxy acrylate-based resin, ultraviolet curable type polyol acrylate-based resin or ultraviolet curable type epoxy resin.

The ultraviolet curable type acryl urethane-based resin can be easily obtained when the product obtained by causing the isocyanate monomer or prepolymer with the polyester polyol is again made to react with the acrylate-based monomer containing a hydroxyl group such as 2-hydroxy ethyl acrylate, 2-hydroxy ethyl methacrylate (hereinafter the acrylate alone will be illustrated on the assumption that the acrylate contains methacrylate) and 2-hydroxypropyl acrylate. For example, the substances disclosed in the Japanese Non-Examined Patent Publication (Tokkaisho) 59-151110 can be used. To put it more specifically, a mixture of 100 parts of Unidic 17-806 (by Dainippon Ink and Chemicals Incorporated) and one part of Coronate L (by Japan Polyurethane) is preferably employed, for example.

The ultraviolet curable type polyester acrylate-based resin can be obtained easily when 2-hydroxy ethyl acrylate and 2-hydroxy acrylate-based monomer is made to react with polyester polyol. The substances disclosed in the Japanese Non-Examined Patent Publication (Tokkaisho) 59-151112 can be employed.

The ultraviolet curable type epoxy acrylate-based resin can be produced, for example, by adding a reactive diluent and photo reaction initiator to the epoxy acrylate as oligomer so as to cause reaction. The substances listed in the Japanese Non-Examined Patent Publication (Tokkaihei) 1-105738 can be utilized.

The ultraviolet curable type polyol acrylate-based resin can be exemplified specifically by trimethylol propane triacrylate, ditrimethylol propane tetraacrylate, pentaerythritol triacrylate, pentaerythritol tetraacrylate, dipenta erythritol hexaacrylate and alkyl denatured dipenta erythritol pentaacrylate.

The photo reaction initiator of the foregoing ultraviolet ray curable resin can be exemplified specifically by benzoyl, its derivative, acetophenone, benzophenone, hydroxy benzophenone, Michler's ketone, α-amyloxime ester, thioxanthone and the derivatives thereof. They can be used together with a photosensitizer. The foregoing photo reaction initiator can be used as a photosensitizer. When using the epoxy acrylate-based photo reaction initiator, a sensitizer such as n-butyl amine, triethylamine and tri-n-butyl phosphine can also be employed. The amount of the photo reaction initiator or photosensitizer used in the ultraviolet ray curable resin composition is 0.1 through 15 parts by mass, preferably 1 through 10 parts by mass with respect to 100 parts by mass of the foregoing composition.

A general monomer such as methyl acrylate, ethyl acrylate, butyl acrylate, benzyl acrylate, cyclohexyl acrylate, vinyl acetate or styrene can be mentioned as a resin monomer, for example, as a monomer with an unsaturated double bond. Ethylene glycol diacrylate, propylene glycol diacrylate, divinyl benzene, 1,4-cyclohexane diacrylate, 1,4-cyclohexyl dimethyl diacrylate, the foregoing trimethylol propane triacrylate and pentaerythritol tetraacryl ester can be mentioned as a monomer having two or more unsaturated double bonds.

The commercially available products of the ultraviolet ray curable resin that can be used in the present invention is exemplified by Adeca Optomer KR.BY Series: KR-400, KR-410, KR-550, KR-566, KR-567, BY-320B (by Asahi Denka Co., Ltd.); Koei Hard A-101-KK, A-101-WS, C-302, C-401-N, C-501, M-101, M-102, T-102, D-102, NS-101, FT-102Q8, MAG-1-P20, AG-106, M-101-C (by Koei Kagaku Co., Ltd.); Seika Beam PHC2210(S), PHC X-9(K-3), PHC2213, DP-10, DP-20, DP-30, P1,000, P1100, P1200, P1300, P1400, P1500, P1600, SCR900 (by Dainichi Seika Kogyo Co., Ltd.); KRM7033, KRM7039, KRM7130, KRM7131, UVECRYL29201, UVECRYL29202 (by Daicel-UCB Co., Ltd.); RC-5015, RC-5016, RC-5020, RC-5031, RC-5100, RC-5102, RC-5120, RC-5122, RC-5152, RC-5171, RC-5180, RC-5181 (by Dainippon Ink and Chemicals Incorporated); Aurex No. 340 Clear (by Chugoku Marine Paints, Ltd.); Sanrad H-601, RC-750, RC-700, RC-600, RC-500, RC-611, RC-612 (by Sanyo Chemical Industries, Ltd.); SP-1509, SP-1507 (by Showa Kobunshi Co., Ltd.); RCC-15C (by Grace Japan), Aronix M-6100, M-8030, M-8060 (by Toagosei Co., Ltd.). An appropriate product can be selected for use from among them.

Trimethylol propane triacrylate, ditrimethylol propane tetraacrylate, pentaerythritol triacrylate, pentaerythritol tetraacrylate, dipenta erythritol hexaacrylate, and alkyl denatured dipenta erythritol pentaacrylate can be mentioned as specific examples of the compounds.

The foregoing actinic radiation curable resin layer can be coated using a commonly known method such as the gravure coater, dip coater, reverse coater, wire bar coater, die coater or inkjet method.

No restriction is imposed on the type of the light source for forming a cured film layer by curing the ultraviolet ray curable resin through photocure reaction, if an ultraviolet ray is emitted. For example, a low voltage mercury lamp, intermediate voltage mercury lamp, high-voltage mercury lamp, extra-high voltage mercury lamp, carbon ark lamp, metal halide lamp and xenon lamp can be used. Conditions for exposure to light vary according to each lamp. The dose of actinic radiation is preferably 5 through 150 mJ/cm², more preferably 20 through 100 mJ/cm².

When the actinic radiation is emitted, tension is preferably applied along the direction of the conveyance of the film, more preferably across the width. The tension to be applied is preferably 30 through 300 N/m.

The organic solvent of the ultraviolet ray curable resin layer composition coating solution is selected as appropriate from among e.g., hydrocarbons (toluene, xylylene), alcohols (methanol, ethanol, isopropanol, butanol, cyclohexanol), ketones (acetone, methyl ethylketone, methyl isobutyl ketone), esters (methyl acetate, ethyl acetate, methyl lactate), glycolethers and other organic solvent. Alternatively, they can be mixed for use. It is preferred to use the foregoing organic solvent containing 5 percent or more by mass, more preferably 5 through 80 percent by mass of propylene glycolmonoalkyl ether (the alkyl group has 1 through 4 carbon atoms) or propylene glycol monoalkylether acetate ester (the alkyl group has 1 through 4 carbon atoms).

A silicone compound is particularly preferred to be added to the ultraviolet ray curable resin layer composition coating solution. For example, polyether denatured silicone oil is preferably added. The appropriate number average molecular weight of the polyether denatured silicone oil is 1,000 through 1,00000, preferably 2,000 through 50,000. If the number average molecular weight is below 1,000, the coated layer drying property is reduced. Conversely, if the number average molecular weight exceeds 1,00000, bleeding out to the coated surface tends to be difficult.

The commercially available silicone compound products preferably used include DK Q8-779® (produced by Dow Coning Corp.); SF3771, SF8410, SF8411, SF8419, SF8421, SF8428, SH200, SH510, SH1107, SH3749, SH3771, BX16-034, SH3746, SH3749, SH8400, SH3771M, SH3772M, SH3773M, SH3775M, BY-16-837, BY-16-839, BY-16-869, BY-16-870, BY-16-004, BY-16-891, BY-16-872, BY-16-874, BY22-008M, BY22-012M and FS-1265® (produced by Dow Coning Toray Co., Ltd.); KF-101, KF-100T, KF351, KF352, KF353, KF354, KF355, KF615, KF618, KF945, KF6004®, Silicone X-22-945 and X22-160AS® (produced by Shin-Etsu Chemical Co. Ltd.); XF3940 and XF3949® (produced by Toshiba Silicone Co., Ltd.); Disparlon LS-009® (produced by Kusumoto Chemicals, Ltd.); Glanol 410® (produced by Kyoeisha Chemical Co., Ltd.); TSF4440, TSF4441, TSF4445, TSF4446, TSF4452 and TSF4460 (produced by GE Toshiba Silicone Co., Ltd.); BYK-306, BYK-330, BYK-307, BYK-341, BYK-344, BYK-361 (by BYK-Chemie Japan, Inc.); and the L series (e.g., L-7001, L-7006, L-7604 and L-9000), the Y series, and the FZ series (e.g. FZ-2203, FZ-2206 and FZ-2207) (produced by Nippon Unicar Co., Ltd.).

These compounds improve the coating performance on the substrates and lower layers. When added to the outermost layer of the laminate, water and oil repellency and antifouling property as well as resistance to surface scratching are improved. The added amount of these components preferably is 0.01-3% by mass with respect to the solid components in the coating solution.

The foregoing method may be used to apply the ultraviolet ray curable resin composition coating solution. Further, in cases when a hard-coat layer is provided, a wet thickness of the hard-coat layer is preferably 20-40 μm, viscosity of that in a wet state is preferably 5-10 cp, and a dry thickness is preferably 10-20 μm.

The hardness of the hard-coat layer is preferably 2H-8H, but more preferably 3H-6H in terms of the pencil hardness. In this case, the pencil hardness is determined as follows: A hard-coat layer sample, having been produced, is subjected to moisture conditioning at a temperature of 25° C. and 60% RH for two hours. Then, using a test pencil specified in the JIS-S-6006, the sample is scratched ten times under a load of 1 kg according to the pencil hardness evaluation method specified in the JIS-K-5400, wherein a pencil of each hardness level is employed. Then the resultant number of scratches without any damage observed is adopted to denote the level of pencil hardness.

The ultraviolet ray curable resin composition is preferably exposed to ultraviolet rays during or after the process of coating and drying. The duration of exposure to achieve the above range of actinic radiation amounting to 5-150 mJ/cm² is preferably 0.1 second-5 minutes. It is more preferably 0.1-10 seconds with regard to improving the ultraviolet ray curable resin curing efficiency and operation efficiency. Further, the intensity of illumination at the exposure section to the actinic radiation is preferably 50-150 mW/m².

The following describes an optical material featuring an antireflection layer. The antireflection layer used in the optical material of the present invention may be designed either as a single layer structure having only a low refractive layer, or as a multi-layered refractive index layer. Normally, the antireflection layer is laminated to the surface of the hard-coat layer (a clear hard-coat layer or an antiglare layer) on the coated member, while considering the refractive index, film thickness, and the number of layers and order of layers to ensure that the reflection factor will be reduced by optical interference. The antireflection layer is consists of a combination of a high refractive layer having a higher refractive index than the coated member and a low refractive layer having a lower refractive index than the coated member. The antireflection layer made up of three or more refractive index layers is particularly preferred. Such a structure is especially preferred especially when it is composed of three layers of different refractive indices; an intermediate refractive layer (exhibiting a higher refractive index than the substrate or the hard-coat layer, and a lower refractive index than the high refractive layer), a high refractive layer and a low refractive layer in that order as viewed from the coated member. The hard-coat layer can also serve as the high refractive layer. Further, in cases when an antirefractive layer is provided, a wet total thickness of the refractive layer is preferably 5-20 μm, a viscosity of that is preferably. 1-5 cp in a wet state, and a dry total thickness of that is preferably 0.1-1 μm.

The following describes the examples of the preferred layer structure of the antireflection layer in the present invention: The slash (being a “/”) indicates a lamination structure.

Coated substrate/hard-coat layer/low refractive layer

Coated substrate/hard-coat layer/high refractive layer/low refractive layer

Coated substrate/hard-coat layer/intermediate refractive layer/high refractive layer/low refractive layer

Coated substrate/antistatic layer/hard-coat layer/intermediate refractive layer/high refractive layer/low refractive layer

Coated substrate/hard-coat layer/intermediate refractive layer/high refractive layer/low refractive layer

Coated substrate/hard-coat layer/high refractive layer/low refractive layer/high refractive layer/low refractive layer <low refractive layer>

In the low refractive layer used in the present invention, the following hollow silica-based minute particles are preferable:

(Hollow Silica-Based Minute Particles)

Hollow minute particles are (I) composite particles made up of porous particles and a coated layer formed on the foregoing porous particles surface; or (II) hollow particles having a hollow interior, which is filled with solvent, gas or porous components. The low refractive layer may contain composite particles (I) and/or hollow particles (II).

The hollow particles contain a hollow interior. The hollow interior is surrounded by a particle wall, and is filled with a solvent, gas or porous components at the time of preparation. Such hollow globular minute particles have an average particles diameter of 5-300 nm, but preferably 10-200 nm. Appropriate hollow globular minute particles to be used are selected in regard to the thickness of the transparent film to be formed, which thickness is preferably ⅔ through 1/10 the thickness of the transparent film, being formed of the low refractive layer and others layers. In order to form a low refractive layer, these hollow globular minute particles are preferably used in a dispersed form in an appropriate medium. The preferred dispersant is water, alcohol (e.g., methanol, ethanol, isopropyl alcohol), ketone (e.g., methyl ethylketone, methyl isobutyl ketone), and ketone alcohol (e.g., diacetone alcohol).

The thickness of the coated layer of the composite particles or the thickness of the particle wall in the hollow particles is 1-20 nm, but preferably 2-15 nm. In the case of the composite particles, when the thickness of the coated layer is less than 1 nm, the particles are not completely covered in some cases, whereby the silicic acid monomer, oligomer and other components having a low degree of polymerization, as the coating solution components to be described later, can easily enter the composite particles, and the internal porosity is reduced, with the result that the advantages of the low refractive index cannot be sufficiently obtained, in these cases. When the thickness of the coated layer exceeds 20 nm, the foregoing silicic acid monomer or oligomer does not penetrate, and the porosity of the composite particles (pore capacity) is reduced, with a similar result that the advantages of a low refractive index cannot be sufficiently obtained, in those cases. In the case of hollow particles, if the thickness of the particle wall is less than 1 nm, the form of particles may not be uniformly maintained, while when the thickness exceeds 20 nm, the targeted effects of a low refractive index may not be sufficiently ensured.

The coated layer of the composite particles, being the wall of the hollow particles, is preferably of silica as a major component, however components other than silica may be included, specifically, being Al₂O₃, B₂O₃, TiO₂, ZrO₂, SnO₂, CeO₂, P₂O₃, Sb₂O₃, MoO₃, ZnO₂ and WO₃. The porous particles constituting the composite particles can be made of silica, silica and an inorganic compound other than silica, and CaF₂, NaF, NaAlF₆, MgF as well as other compounds. Of these, porous particles of a composite oxide made of silica and an inorganic compound other than silica are preferable. Two or more of Al₂O₃, B₂O₃, TiO₂, ZrO₂, SnO₂, CeO₂, P₂O₃, Sb₂O₃, MoO₃, ZnO₂, WO₃ and other appropriate compounds may be cited as an inorganic compound other than silica. In such porous particles, when the silica is represented by SiO₂ and the inorganic compound other than silica is expressed by an oxide equivalent (MO_{X}), the mole ratio of MO_{X} to SiO₂ is 0.0001-1.0, but preferably 0.001-0.3. It is difficult to produce porous particles at a mole ratio of MO_{X} to SiO₂ below 0.0001. Even when such particles are produced, it is not possible to make them of a smaller volume and/or lower refractive index. When the mole ratio of MO_{X} to SiO₂ of the porous particles exceeds 1.0, the proportion of the silica is reduced, while the pore volume is increased. This makes it difficult to produce particles of a lower refractive index.

The pore volume of such porous particles is preferably 0.1-1.5 ml/g, but more preferably 0.2-1.5 ml/g. If the pore volume is less than 0.1 ml/g, particles with a reduced refractive index cannot be produced. If the pore volume exceeds 1.5 ml/g, the strength of the particles is reduced, with the result in such cases that the strength of the film obtained is reduced. It is to be noted that the pore volume of such porous particles can be obtained by the method of mercury penetration. Further, the contents of the hollow particles are the solvent, gas, porous substances and other components, which are used at the time of preparing the particles. The solvent may contain the unreacted product of the particles precursor used when preparing the hollow particles, the used catalyst and other components. The porous substances are exemplified by the compounds shown as the foregoing porous particles. These contents may be either single components or a mixture of a plurality of such components.

Such hollow globular minute particles are preferably produced by the method for preparing composite oxide colloid particles disclosed in paragraphs [0010]-[0033] of JP-A 7-133105.

The refractive index of the hollow minute particle obtained in this manner is low due to a hollow internal structure, and therefore. The refractive index of the low refractive layer employed in the present invention using the same is preferably 1.30-1.50, but more preferably 1.35-1.44.

The amount (mass) of the hollow silica-based minute particles, having an outer shell layer and an internal porous or hollow structure, contained in the low refraction layer coating solution is preferably 10-80% by mass, but more preferably 20-60% by mass.

(Tetraalkoxy Silane Compound or Hydrolysate Thereof)

The low refractive layer of the present invention preferably contains a tetraalkoxy silane compound or the hydrolysate thereof as a sol-gel material.

In addition to the foregoing inorganic silicon oxide, the silicon oxide containing an organic group is preferably used as a material of the low refractive layer used in the present invention, which are generally referred to as a sol-gel material. The metallic alcoholate, organoalkoxy metallic compound and the hydrolysate thereof may be used, and of which, particularly preferred alkoxy silane, organoalkoxy silane and hydrolysate. These organic silane are exemplified by tetraalkoxy silane (e.g., tetramethoxy silane, tetraethoxy silane); alkyl trialkoxy silane (e.g., methyl trimethoxy silane, ethyltrimethoxy silane); aryl trialkoxy silane (phenyltrimethoxy silane); dialkyl dialkoxy silane; and diaryl dialkoxy silane.

The foregoing silicon oxide and the following silane coupling agent are preferably used as the low refractive layer used in the present invention.

Specific examples of the silane coupling agent are methyl trimethoxy silane, methyltriethoxy silane, methyltrimethoxyethoxy silane, methyl triacetoxy silane, methyltributoxy silane, ethyltrimethoxy silane, ethyl triethoxy silane, vinyltrimethoxy silane, vinyltriethoxy silane, vinyltriacetoxy silane, vinyltrimethoxyethoxy silane, phenyltrimethoxy silane, phenyltriethoxy silane, and phenyltriacetoxy silane.

Examples of the silane coupling agent having a disubstituted alkyl group with respect to silicon are dimethyl dimethoxy silane, phenylmethyl dimethoxy silane, dimethyl diethoxy silane, and phenylmethyl diethoxy silane.

Specific examples of the silane coupling agent are KBM-303, KBM-403, KBM-402, KBM-403, KBM-1403, KBM-502, KBM-503, KBE-502, KBE-503, KBM-603, KBE-603, KBM-903, KBE-903, KBE-9103, KBM-802 and KBM-803, produced by Shin-Etsu Chemical Co., Ltd.

These silane coupling agents are preferably hydrolyzed in advance using the required amount of water. If the silane coupling agent is hydrolyzed, the surfaces of the foregoing silicon oxide particles and the silicon oxide containing the organic group will react more readily, with the result that a stronger film is formed. Further, the hydrolyzed silane coupling agent can be added into the coating solution in advance.

The low refractive layer may contain 5-50% polymer by mass. The polymer bonds the particles together, and maintains the structure of the low refractive layer including the void. The amount of the polymer to be used is adjusted to maintain the strength of the low refractive layer without filling the gap. The amount of the polymer is preferably 10-30% by mass of the entire low refractive layer. To bond the particles by polymer, it is preferred to: (1) bond the polymer to the surface processing agent of the particles, (2) form a polymer shell around the particle which serves as a core, or (3) use a polymer as a binder between particles.

The binder polymer preferably contains a saturated hydrocarbon or a polyether, but more preferably contains a saturated hydrocarbon as a principal chain. The binder polymer is preferably crosslinked. The polymer, featuring a saturated hydrocarbon as the principal chain, is preferably obtained by a polymerization reaction of the ethylenic unsaturated monomer. To realize a cross-linked binder polymer, use of a monomer having two or more ethylenic unsaturated groups is preferred. Examples of the monomer exhibiting two or more ethylenic unsaturated groups include the ester of the polyvalent alcohol and (meth)acrylic acid (e.g., ethylene glycol di(meth)acrylate, 1,4-dichlorohexane diacrylate, pentaerythritol tetra(meth)acrylate, pentaerythritol tri(meth)acrylate, trimethylol propane tri(meth)acrylate, trimethylol ethane tri(meth)acrylate, dipenta erythritol tetra(meth)acrylate, dipenta erythritol penta(meth)acrylate, pentaerythritol hexa(meth)acrylate, 1,2,3-cyclohexane tetramethacrylate, polyurethane polyacrylate, polyester polyacrylate); vinyl benzene and the derivative thereof (e.g., 1,4-di vinyl benzene, 4-vinyl benzoic acid-2-acryloyl ethyl ester, 1,4-di vinylcyclohexane); vinylsulfone (e.g., divinylsulfone); acrylamide (e.g., methylene bisacrylamide); and methacrylamide.

The low refractive layer used in the present invention is preferably a fluorine-containing resin to be crosslinked by heat or ionizing radiation (hereinafter also referred to as “pre-crosslinking fluorine-containing resin”).

The pre-crosslinking fluorine-containing resin is preferably exemplified by the fluorine-containing copolymer formed of a fluorine-containing vinyl monomer and a monomer which gives a crosslinking group. The foregoing fluorine-containing vinyl monomer unit is specifically exemplified by fluoro olefins (e.g., fluoroethylene, vinylidene fluoride, tetrafluoroethylene, hexafluoroethylene, hexafluoropropylene, perfluoro-2,2-dimethyl-1,3-dioxole), partially or completely fluorinated alkyl ester derivatives of the (meth)acrylic acid [e.g., Viscoat 6FM (produced by Osaka Organic Chemical Industry Ltd.), M-2020 (produced by Daikin Industries Ltd.)], and partially or completely fluorinated vinylethers. The monomer for adding a cross-linking group is exemplified by the vinyl monomer having a cross-linked functional group in the molecule in advance such as glycidylmethacrylate, vinyltrimethoxy silane, γ-methacryloyl oxypropyltrimethoxy silane and vinylglycidylether, as well as a vinyl monomer containing a carboxyl group, hydroxyl group, amino group, sulfonic acid group [e.g., (meth)acrylic acid, methylol(meth)acrylate, hydroxy alkyl(meth)acrylate, alyl acrylate, hydroxy alkyl vinyl ether, hydroxy alkyl alyl ether]. JP-A Nos. 10-25388 and 10-147739 describe the method of introducing the cross-linked structure to the latter monomer, by adding the compound containing a group reacting with the functional group in the polymer and one or more other reactive groups subsequent to copolymerization. This cross-linking group is exemplified by acryloyl, methacryloyl, isocyanate, epoxy, aziridine, oxazoline, aldehyde, carbonyl, hydrazine, carboxyl, methylol and an activated methylene group. If the fluorine-containing copolymer is cross-linked by heating through a cross-linking group which reacts by heating, a combination of the ethylenic unsaturated group thermal radial generator, or a combination of an epoxy group and thermal acid generator, this copolymer is called as a thermosetting type. If this copolymer is cross-linked by exposure to light (preferably ultraviolet rays, electron beams) through a combination between the ethylenic unsaturated group and optoradical generator, or a combination between the epoxy group and photooxy-generating agent, this copolymer is called as an ionizing radiation curable type.

The following percentage of the foregoing monomers is preferably adopted to form a fluorine-containing copolymer before crosslinking: The fluorine-containing vinyl monomer is preferably 20-70 mol %, but more preferably 40-70 mol %. The monomer to add a cross-linking group is preferably 1-20 mol %, but more preferably 5-20 mol %. Other monomers used in combination are preferably 10 through 70 mole %, more preferably 10 through 50 mole %.

The low refractive layer used in the present invention can be coated and formed according to the dip coating method, air knife coating method, curtain coating method, roller coating method, wire bar coating method, gravure coating method or extrusion coating method (see U.S. Pat. No. 2,681,294). Simultaneous coating of two or more layers is also possible. The method of simultaneous coating is disclosed in U.S. Pat. Nos. 2,761,791, 2,941,898, 3,508,947 and 3,526,528, and Coating Engineering by HARASAKI Yuji, p. 253, Asakura Publishing Co., Ltd. (1973).

The thickness of the low refractive layer in the present invention is preferably 50-200 nm, but more preferably 60 through 150 nm.

<High Refractive Layer and Intermediate Refractive Layer>

In the present invention, a high refractive layer is preferably arranged between the transparent substrate and low refractive layer to reduce the reflection factor. Further, an intermediate refractive layer is more preferably provided between the foregoing transparent substrate and high refractive layer to further reduce the reflection factor. The refractive index of the high refractive layer is preferably 1.55-2.30, but more preferably 1.57-2.20. The refractive index of the intermediate refractive layer is adjusted to a value intermediate between the refractive index of the transparent substrate and that of the high refractive layer. The refractive index of the intermediate refractive layer is preferably 1.55-1.80. The thickness of the high refractive layer and intermediate refractive layer is preferably 5 nm-1 μm, more preferably 10 nm-0.2 μm, but most preferably 30 nm-0.1 μm. The haze of the high refractive layer and intermediate refractive layer is preferably 5% or less, more preferably 3% or less, but most preferably 1% or less. The hardness of the high refractive layer and intermediate refractive layer is preferably 1H or more in terms of pencil hardness under a load of 1 kg, more preferably 2H or more, but most preferably 3H or more.

The intermediate and high refractive layers used in the present invention are preferred to be a layer having a refractive index of 1.55-2.5 which is formed by coating the solution containing the monomer, oligomer or the hydrolysate thereof of an organic titanium compound expressed by the following general formula (1), and by drying the layer thereafter.
Ti(OR₁)₄ Formula (1)

In the formula, R₁ is an aliphatic hydrocarbon group having preferably 1-8 carbon atoms, but more preferably 1-4 carbon atoms. Further, in the monomer, oligomer or hydrolysate of the organic titanium compound, the alkoxide group is subjected to hydrolysis to cause reaction such as in —Ti—O—Ti—, whereby a cross-linked structure is created and a cured layer is formed.

The monomer or oligomer of the organic titanium compound used in the present invention is exemplified by a dimer through decamer of Ti(OCH₃)₄, Ti(OC₂H₅)₄, Ti(O-n-C₃H₇)₄, Ti(O-i-C₃H₇)₄, Ti(O-n-C₄H₉)₄ or Ti(O-n-C₃H₇)₄; a dimer through decamer of Ti(O-i-C₃H₇)₄; and a dimer through decamer of Ti(O-n-C₄H₉)₄. They can be used independently or in combination of two or more. Among others, a dimer through decamer of Ti(O-n-C₃H₇)₄, Ti (O-i-C₃H₇)₄, Ti (O-n-C₄H₉)₄ or Ti (O-n-C₃H₇)₄ and a dimer through decamer of Ti(O-n-C₄H₉)₄ may be used for specific preferred performance.

The monomer, oligomer or the hydrolysate of the organic titanium compound used in the present invention preferably accounts for 50.0-98.0% by mass of the solids contained in the coating solution. The proportion of solids is preferably 50-90% by mass, but more preferably 55-90% by mass. Further, the polymer of the organic titanium compound (cross-linked by hydrolysis of the organic titanium compound) or particles of titanium oxide, is preferably added to the coating composition.

High refractive layers and intermediate refractive layers used in the present invention preferably contain metallic oxide particles as particles, but more preferably as binder polymers.

If metallic oxide particles are combined with the organic titanium compound hydrolyzed or polymerized according to the foregoing method of preparing the coating solution, the metallic oxide particles are firmly bonded to the organic titanium compound having been hydrolyzed or polymerized. This produces a coated layer characterized by excellent hardness and uniform film flexibility of these particles.

The metallic oxide particles used in the high refractive layer and intermediate refractive layer preferably feature a refractive index of preferably 1.80-2.80, but more preferably 1.90-2.80. The mass average diameter of the primary particles of the metallic oxide particles is preferably 1-150 nm, more preferably 1-100 nm, but most preferably 1-80 nm. The mass average diameter of the metallic oxide particles in the layer is preferably 1-200 nm, more preferably 5-150 nm, still more preferably 10-100 nm, but most preferably 10-80 nm. If the average particle diameter of the metallic oxide particles is more than 20-30 nm, a light-scattering method is used for measurement. If the average particle diameter does not exceed 20-30 nm, an electron micrograph is used for measurement. The specific surface area of the metallic oxide particles is preferably 10-400 m²/g in terms of the value obtained by measurement according to BET method, more preferably 20-200 m²/g, but most preferably 30-150 m²/g.

The metallic oxide particle is exemplified by a metallic oxide containing at least an element selected from among Ti, Zr, Sn, Sb, Cu, Fe, Mn, Pb, Cd, As, Cr, Hg, Zn, Al, Mg, Si, P and S. More specifically, titanium dioxide (e.g., rutile and rutile/anatase mixed crystal, anatase, amorphous structure), tin oxide, indium oxide, zinc oxide, and zirconium oxide can be listed. Especially, titanium oxide, tin oxide and indium oxide are particularly preferred. The metallic oxide particles made from of the oxide of these metals as a major component may further include other elements. The major component may be defined as the component contained in the greatest proportion (percent by mass), of the components constituting the particles. Examples of other elements include Ti, Zr, Sn, Sb, Cu, Fe, Mn, Pb, Cd, As, Cr, Hg, Zn, Al, Mg, Si, P and S.

The metallic oxide particles are preferably subjected to a surface treatment, which may be provided using inorganic or organic compounds. The inorganic compounds used for surface treatment are exemplified by alumina, silica, zirconium oxide and iron oxide, of which the alumina and silica are specifically preferable. The organic compounds usable for surface treatment are exemplified by polyol, alkanolamine, stearic acid, silane coupling agent and titanate coupling agent, of which, the silane coupling agent is most preferable.

The proportion of the metallic oxide particles contained in the high refractive layer and intermediate refractive layer is preferably 5-65% by volume, more preferably 10-60%, but still more preferably 20-55%.

The foregoing metallic oxide particles when dispersed in a medium are supplied to the coating solution to form a high refractive layer and an intermediate refractive layer. A liquid having a boiling point of 60-170° C. is preferably used as the dispersive medium of the metallic oxide particles. The dispersed solvent is exemplified by water, alcohol (e.g., methanol, ethanol, isopropanol, butanol, and benzyl alcohol), ketone (e.g., acetone, methyl ethylketone, methyl isobutyl ketone, and cyclohexane), ester (e.g., methyl acetate, ethyl acetate, propyl acetate, butyl acetate, methyl formate, ethyl formate, propyl formate, and butyl formate), aliphatic hydrocarbon (e.g., hexane, and cyclohexane), halogenated hydrocarbon (e.g., methylene chloride, chloroform, and carbon tetrachloride), aromatic hydrocarbon (e.g., benzene, toluene, and xylylene), amide (e.g., dimethyl formamide, dimethyl acetoamide, and n-methylpyrrolidone), ether (e.g., diethylether, dioxane, and tetrahydrofuran), and ether alcohol (e.g., 1-methoxy-2-propanol), of which toluene, xylylene, methyl ethylketone, methyl isobutyl ketone, cyclohexane and butanol are specifically preferred.

The above metallic oxide particles can be dispersed in an appropriate medium by using a homogenizer, which is exemplified by a sand grinder mill (e.g., bead mill with pins), a high-speed impeller mill, a pebble mill, a roller mill, an attriter and a colloid mill). Of these, the sand grinder mill and high-speed impeller mill are particularly preferred. Further, a process of preliminary dispersion can also be employed. The homogenizer used for preliminary dispersion is exemplified by a ball mill, a three-roller mill, a kneader and an extruder.

For the high refractive layer and intermediate refractive layer used in the present invention, a polymer containing the polymer exhibiting a cross-linked structure (hereinafter referred to in some cases as “cross-linked polymer”) is preferably used as a binder polymer. The cross-linked polymer is exemplified by cross-linked substances such as a polymer, polyether, polyurea, polyurethane, polyester, polyamine, polyamide and melamine resin including saturated hydrocarbon chains such as polyolefin. Especially, preferred is the cross-linked substance of the polyolefin, polyether and polyurethane. The cross-linked substance of the polyolefin and polyether is more preferable, of which cross-linked substance of polyolefin is most preferred.

The monomer containing two or more ethylenic unsaturated groups is most preferable as the monomer used in the present invention. This monomer is exemplified by the esters of polyvalent alcohol and (meth)acrylic acid (e.g., ethylene glycol di(meth)acrylate, 1,4-dichlorohexane diacrylate, pentaerythritol tetra(meth)acrylate, pentaerythritol tri(meth)acrylate, trimethylol propane tri(meth)acrylate, trimethylol ethane tri(meth)acrylate, dipenta erythritol tetra(meth)acrylate, dipenta erythritol penta(meth)acrylate, pentaerythritol hexa(meth)acrylate, 1,2,3-cyclohexane tetramethacrylate, polyurethane polyacrylate, polyester polyacrylate), vinyl benzene and the derivative thereof (e.g., 1,4-di vinyl benzene, 4-vinyl benzoic acid-2-acryloyl ethyl ester, 1,4-di vinylcyclohexanone), vinylsulfone (e.g., divinylsulfone), acrylamide (e.g., methylene bisacrylamide) and methacryl amide. The monomer containing an anionic group and the monomer containing an amino group or quaternary ammonium group may be used as commercially available monomers. The monomer containing a preferable commercial anionic group is exemplified by Kayamar PM-21, PM-2 (produced by Nippon Kayaku Co.), Antox MS-60, MS-2N, MS-NH4 (produced by Nippon Nyukazai Co., Ltd.), the Aronix M-5000, M-6000, and M-8000 series (produced by To a Gosei Co., Ltd.), the Biscoat #2000 series (produced by Osaka Organic Chemical Industry Ltd.), New Frontier GX-8289 (produced by Dai-Ichi Kogyo Seiyaku Co., Ltd.), NK ester CB-1 and A-SA (produced by Shin-Nakamura Chemical Co., Ltd.), and AR-100, MR-100 and MR-200 (Daihachi Chemical Industries Co., Ltd.). The monomer containing a preferable commercial amino group or quaternary ammonium group is exemplified by DMAA (produced by Osaka Organic Chemical Industry Ltd.), DMAEA, DMAPAA (produced by Koujin Co., Ltd.), Bremmar QA (produced by NOF Corp.) and New Frontier C-1615 (produced by Dai-Ichi Kogyo Seiyaku Co., Ltd.).

Photo-polymerization reaction or thermal polymerization reaction are appropriate for the polymerization reaction of these polymers. Particularly, the photo-polymerization reaction is preferred. Use of a polymerization initiator is preferred to promote polymerization reaction. For example, it is possible to describe the thermal polymerization initiator and photo-polymerization initiator used to form the binder polymer of the hard-coat layer.

A commercially available polymerization initiator may be used as a polymerization initiator. In addition to the polymerization initiator, a polymerization accelerating agent may also be employed. The amount of the polymerization initiator and polymerization accelerating agent to be added is preferably 0.2-10% by mass with respect to the total amount of the monomer.

Each layer of the antireflection layer or the coating solution thereof may be provided with a polymerization inhibitor, leveling agent, thickener, anti-coloring agent, ultraviolet ray absorbent agent, silane coupling agent, antistatic agent and an adhesion intensifier, in addition to the foregoing components (metallic oxide particles, polymer, dispersion medium, polymerization initiator and polymerization accelerating agent).

After the high, intermediate, and low refractive layers have been provided, exposure to actinic radiation is preferred to accelerate hydrolysis or curing of the composition, including a metallic alkoxide. It is more preferred to allow exposure to actinic radiation after each layer has been coated.

The actinic radiation used in the present invention is exemplified by ultraviolet rays, electron beams and gamma rays. There is no restriction as long as it is an energy source which activates the compound, of which ultraviolet rays and electron beams are specifically preferred. Use of ultraviolet rays is particularly preferred for easier handling and easier acquisition of high energy. However any appropriate light source is allowed as an ultraviolet ray light source for photo-polymerization of the ultraviolet ray reactive compound as long as it generates ultraviolet rays. For example, a low voltage mercury lamp, an intermediate voltage mercury lamp, a high-voltage mercury lamp, an extra-high voltage mercury lamp, a carbon arc lamp, a metal halide lamp and a xenon lamp may be utilized. It is also possible to use an ArF excimer, a KrF excimer, an excimer lamp or a synchrotron radiation. Light exposure conditions of course differ according to each lamp, but the amount of light is preferably 20-1,0000 mJ/cm², more preferably 100-2,000 mJ/cm², but still more preferably 400-2,000 mJ/cm².

### EXAMPLE

The following describes the details of the present invention with reference to the following Examples, without the present invention being restricted thereto.

### Example 1

<<Production of Cellulose Ester Film>>

A cellulose ester film as a resin film substrate was produced by preparing various types of liquid additives and dopes as shown below.

(Production of Cellulose Ester Film)

<Preparation of Silicon Oxide Dispersion Liquid A>

| | |
|---|---|
| AEROSIL R972V (produced by Nippon Aerosil Co., | 1 kg |
| Ltd.) | |
| Ethanol | 9 Kg |

Silicon Oxide Dispersion Liquid A was prepared via the steps of stirring and mixing the foregoing material in a dissolver for 30 minutes, and dispersing the mixture using a Manton-Gaulin high pressure homogenizer.

<Preparation of Liquid Additive B>

| | |
|---|---|
| Cellulose triacetate (at an acetyl group replacement | 6 kg |
| ratio of 2.88) | |
| Methylene chloride | 140 kg |

Liquid Additive B was prepared via the steps of ppuring the foregoing material into an enclosed container, heating and stirring to completely dissolve the mixture and filtering the mixture. This was followed by the steps of adding 10 kg of foregoing Silicon Oxide Dispersion Liquid A to the mixture while stirring, further stirring the mixture for another 30 minutes, and filtering the mixture.

<Preparation of Dope C>

| | | |
|---|---|---|
| Methylene chloride | 440 | kg |
| Ethanol | 35 | kg |
| Cellulose triacetate (at a acetyl group replacement | 100 | kg |
| ratio of 2.88) | | |
| Triphenyl phosphate | 10 | kg |
| Ethylphthalyl ethylglycolate | 2 | kg |
| TINUVIN 326(produced by Ciba Specialty | 0.3 | kg |
| Chemicals) | | |
| TINUVIN 109(by Ciba Specialty Chemicals) | 0.5 | kg |
| TINUVIN 171(by Ciba Specialty Chemicals) | 5 | kg |

Dope C was prepared via the steps of pouring the foregoing solvent into an enclosed container, adding the remaining materials while stirring, completely dissolving the solution while heating and stirring, and mixing the solution. This was followed via steps of reducing the temperature for dope casting, allowing the solution to stand overnight, removing any gas bubbles, and filtering the solution with filter paper Azumi #244 (produced by AZUMI FILTERPAPER CO., LTD). This was followed by the steps of adding 3 kg of liquid additive B to the foregoing solution, mixing the solution with an in-line mixer (static in-line mixer Hi-Mixer SWJ (produced by Toray Industries, Inc.), and filtering the resultant.

Having been filtered, the dope, at 35° C. was uniformly cast over a stainless steel band substrate of 35° C., using a belt casting apparatus. After that, it was dried on the substrate, and the film was separated from the stainless steel band substrate. The amount of the residual solvent of the film at this stage was 80%. After having been separated from the stainless steel band substrate, the film was dried for one minute in an 80° C. drying zone. Using a biaxial orientation tenter, the film was oriented at a drawing factor of 0.98 along the length, and at a drawing factor of 1.1 across the width in an environment of 100° C. when the amount of residual solvent was 3-10% by mass. Edge gripping was then released and the film was dried in 125° C. drying zone while being conveyed on a plurality of rolls. Upon termination of drying, both edges of the film were knurled to a width of 10 mm and a height of 10 μm, whereby a long and wide cellulose ester film was produced. This film was 80 μm thick, 1,400 mm wide and 2,500 m long.

<<Preparation of Coating Composition to Form a Clear Hard-
Coat Layer>>

| | |
|---|---|
| Dipenta erythritol hexaacrylate | 100 parts* |
| (including the components of dimer, trimer and so on)) | |
| Photo reaction initiator (being Irgacure 184 | 4 parts |
| Produced by Ciba Specialty Chemicals) | |
| Propylene glycol monomethylether | 75 parts |
| Methyl ethylketone | 75 parts |

*parts: parts by mass

These materials were mixed to form a clear hard-coat layer coating solution.

<<Formation of Clear Hard-Coat Layer>>

Using the coating/drying apparatus shown in FIG. 1, the following steps were taken to form a clear hard-coat layer. One surface of the cellulose ester film was coated with the clear hard-coat layer formation coating solution, at a conveyance rate of 30 m/min. with an extrusion type die coater for a coated width of 1,200 mm, and a wet thickness of 10 μm. Then the cellulose ester film, carrying the clear hard-coat layer was dried with 70° C. dry air in the first drying zone. When the solid concentration in the clear hard-coat layer was 80% by volume or less, the clear hard-coat cellulose ester film was float-supported and conveyed by the conveyance apparatus. After that, any residual solvent in the coated layer was evaporated at a drying temperature of 120° C. in the second drying zone. Then in a curing section, the coated layer was exposed to ultraviolet rays having a light intensity of 150 mJ/cm², whereby the coated film was cured. Then the film was cooled to room temperature and wound on a recovery section, whereby samples No. 101-109 were produced.

<<Conveyance by the First Drying Apparatus>>

The floating support units used in the test had a width of 1,450 mm (being across the width of the substrate), and a length of 220 mm (being along the direction of the conveyance of the substrate).

Three blowing outlets of the floating support units were used, which had a width of 1,430 mm (being across the width of the substrate), an interval of 3 mm (being along the direction of the conveyance of the substrate), and a pitch of 100 mm along the direction of conveyance of the substrate. More specifically, the first blow outlet was located at 10 mm from the side wall, the second one was located 100 mm from the first one, and the third one was also located 100 mm from the second one, that is, at 10 mm from the opposite side wall.

Twenty floating support units were arranged in the form of an arch on the installation surface of the floating gas header, said arch having a diameter of 10 m (the coordinate arrangement at the central position along the direction of conveyance of the upper surface of the floating support unit) at a pitch of 300 mm, wherein the difference in height between the upper surface of the floating support unit and the installation surface was 150 mm.

The foregoing cellulose ester film was conveyed in a floating state by a conveyance apparatus equipped with the floating support units. This procedure ensured that the ratio between the area where the cellulose ester film, supported by the floating units and the area where the film was not supported was 7.3:2.7, the width of the blow outlets was +30 mm greater with respect to the width of the cellulose ester film, and the interval of changes in back pressure was 150 mm along the direction of conveyance.

Other conditions for the conveyance apparatus were set as follows: The temperature of the gas blown against the uncoated surface from the blow outlets of the floating support unit was set at 40° C. (gas temperature indicating the value measured by the temperature measuring tube installed inside the floating support units), the velocity of the gas blown against the uncoated surface from the blow outlets of the floating support units (gas velocity indicating the value measured by the hot-wire anemometer) was set at 15 m/s, and the tension along the direction of conveyance (tension showing the value measured by the tension pickup roller installed on the conveyance line) was set at 180 N/m.

Thus, the cellulose ester film was conveyed under the following conditions: The distance (amount of floatation) between the upper surface of the floating support unit and the back pressure surface of the cellulose ester film was 15 mm, the distance between the installation surface of the floating support unit and the uncoated surface of the cellulose ester film was 165 mm, and the maximum value of the back pressure was 100 Pa. It is to be noted that the back pressure was obtained as follows: The SUS-made tube having an outer diameter of 1 mm and an inner diameter of 0.5 mm was inserted between the floating support unit and substrate. Then the static pressure was measured by the Manostar Gauge. This measurement was used as the back pressure value.

Under the foregoing conditions, the cellulose ester film carrying the clear hard-coat layer coated film was conveyed in a floating state by the conveyance apparatus along the direction of conveyance, while the back pressure against the uncoated surface, via the blown gas was changed, as shown in following Table 1. The back pressure was regulated by changing the blown gas velocity. This changed the distance between the cellulose ester film and the upper surface of the floating support unit.

Evaluation

Uniformity in film thickness was measured by the following method for each of Samples Nos. 101-109. Evaluation was conducted based on the following rankings, the results of which are shown in following Table 1. Method of measuring the uniformity in film thickness (variations in the thickness of the coated film)

A total of 24 samples—the foregoing twelve samples at a pitch of 100 mm across the width and the twelve samples 2 m away along the length—were used in the test. The film thickness was measured with a light interference film thickness gauge Model FE-3000 produced by Otsuka Densi Co., Ltd., and the uniformity in film thickness was calculated based on the following formula:
Variation in coated film thickness=(maximum film thickness−minimum film thickness)/average film thickness X 100 (%)

Evaluation ranking of uniformity in film thickness

A: 4% or less

B: 8% or less

C: 12% or less

D: 18% or less

E: More than 18%

TABLE 1

| | Change in | Uniformity of | |
|---|---|---|---|
| Sample No. | back pressure | film thickness | Remarks |
| 101 | 3 | E | Comparative example |
| 102 | 10 | C | Present invention |
| 103 | 30 | B | Present invention |
| 104 | 100 | A | Present invention |
| 105 | 300 | A | Present invention |
| 106 | 500 | A | Present invention |
| 107 | 800 | B | Present invention |
| 108 | 1,000 | C | Present invention |
| 109 | 1,200 | E | Comparative example |

The foregoing evaluation test demonstrated the validity of the present invention.

### Example 2

The cellulose ester film containing the same clear hard-coat layer as that of Sample No. 104 produced in Example 1 was produced under the same conditions using the same components. The following intermediate refractive layer formation coating solution was applied on the clear hard-coat layer by an extrusion type die coater. After that, keeping the dry air temperature of the first drying machine at 80° C., the cellulose ester film containing the intermediate refractive layer formation coated film was float-supported and conveyed by the cited conveyance apparatus, until the solid concentration in the intermediate refractive layer film did not exceed 80% by volume. The coated layer was dried, and any residual solvent in the coated layer was removed in the second drying apparatus at 120° C. After that, in the curing section, the coated layer was exposed to ultraviolet rays at a light intensity of 300 mJ/cm², and was then cooled to room temperature. The film was then wound on a core in the recovery section.

After that, the intermediate refractive layer was coated with a high refractive layer coating solution, and dried under the same conveying and drying conditions as those of the intermediate refractive layer. The coated layer was cured under the same conditions and was cooled to room temperature. Then the film was wound on a core in the recovery section. After that, the high refractive layer was coated with a low refractive layer coating solution, and dried under the same conveying and drying conditions as those of the intermediate refractive layer. The coated layer was cured under the same conditions and cooled to room temperature. Then the film was wound on a core in the recovery section, whereby Samples Nos. 201-209 were produced. The film thickness of each refractive index layer was 0.1 μm.

<<Conveyance in the First Drying Zone>>

The floating support units used in the test was at a width of 1,450 mm (being across the width of the substrate), and a length of 220 mm (being along the direction of the conveyance of the substrate).

The three blowing outlets of the floating support unit were used, which had a width of 1,430 mm (across the width of the substrate), a gap of 3 mm (along the direction of conveyance of the substrate), and a pitch of 100 mm along the direction of conveyance of the substrate.

Twenty floating support units were arranged in the form of an arch on the installation surface of the floating gas header, said arch having a diameter of 10 m (the coordinate arrangement at the central position along the direction of conveyance of the upper surface of the floating support unit) at a pitch of 300 mm, wherein the difference in height between the upper surface of the floating support unit and the installation surface was 150 mm.

The foregoing cellulose ester film was conveyed in a floating state by a conveyance apparatus equipped with the floating support unit. This procedure ensured that the ratio between the area where the cellulose ester film supported by the floating unit and the area where the film was not supported was 7.3:2.7, the width of the blow outlet was +30 mm with respect to the width of the cellulose ester film, and the interval of changes in back pressure was 150 mm along the direction of conveyance.

Other conditions for the conveyance apparatus were set as follows: The temperature of the gas blown onto the uncoated surface from the blow outlets of the floating support unit was set at 40° C. (gas temperature indicating the value measured by the temperature measuring tube installed inside the floating support unit), the velocity of the gas blown to the uncoated surface from the blow outlet of the floating support unit (gas velocity indicating the value measured by the hot-wire anemometer) was set at 15 m/s, and the tension along the direction of conveyance (tension showing the value measured by the tension pickup roller installed on the conveyance line) was set at 180 N/m.

Thus, the cellulose ester film was conveyed under the following conditions: The distance (amount of floatation) between the upper surface of the floating support unit and the back pressure surface of the cellulose ester film was 15 mm, the distance between the installation surface of the floating support unit and the uncoated surface of the cellulose ester film was 165 mm, and the maximum value of the back pressure was 100 Pa. It is to be noted that the back pressure was obtained as follows: The SUS-made tube at an outer diameter of 1 mm and an inner diameter of 0.5 mm was inserted between the floating support unit and substrate. Then the static pressure was measured by the manostat gauge. This measurement was used as the back pressure value.

Under the foregoing conditions, the cellulose ester film carrying the clear hard-coat layer was conveyed in a floating state by a conveyance apparatus along the direction of conveyance, while the back pressure against the uncoated surface, via the blown gas was changed, as shown in following Table 2. The back pressure was regulated by changing the blown gas velocity. This changed the distance between the cellulose ester film and the upper surface of the floating support unit. By this, the distance between the cellulose ester film and the upper surface of the floating support unit was changed. Under these conditions, the cellulose ester film carrying the clear hard-coat layer was conveyed in a floating state by a conveyance apparatus along the direction of conveyance, while the back pressure against the uncoated surface, provided by blown gas was changed, as shown in Table 1.

<Intermediate Refractive Layer Coating Solution>

| | | |
|---|---|---|
| Titanium tetrabutoxide | 9.5 | g |
| γ-methacryloxypropyltrimethoxy silane | 0.9 | g |
| Cationic curable resin (being KR-566, | 0.9 | g |
| produced by Asahi Denka Co., Ltd.) | | |
| 2-propanol | 75 | ml |
| Dimethyl formamide | 8 | ml |
| Aqueous solution containing | 2.6 | ml |
| 10% hydrochloric acid | | |

<High Refractive Layer Coating Solution>

| | | |
|---|---|---|
| Titanium tetrabutoxide | 14.5 | g |
| γ-methacryloxypropyltrimethoxy silane | 0.25 | g |
| Cationic curable resin (KR566-39, | 0.25 | g |
| produced by Asahi Denka Co., Ltd.) | | |
| 1-butanol | 75 | ml |
| Dimethyl formamide | 3 | ml |
| Aqueous solution containing | 3 | ml |
| 10% hydrochloric acid | | |

<Low Refractive Layer Coating Solution>

| | | |
|---|---|---|
| Tetraethoxy silane hydrolysate* | 27 | g |
| γ-methacryloxypropyltrimethoxy silane | 0.8 | g |
| Aluminum trisethylacetoacetate | 0.8 | g |
| Silica particle dispersed with 2% acetone | 30 | ml |
| (dispersion by ultrasonic wave) | | |
| (Trade name: AEROSIL 200 by Nippon Aerosil Co., Ltd.) | | |
| Cyclohexane | 50 | ml |
| Fluorine-based surface active agent | 0.1 | g |
| (Megafac F-172, produced by Dainippon Ink | | |
| and Chemicals Incorporated) | | |

*Method of preparing the tetraethoxy silane ydrolysate

The tetraethoxy silane hydrolysate was prepared by taking the following steps: 380 g of ethanol was added to 250 g of tetraethoxy silane. Then an aqueous solution containing hydrochloric acid obtained by dissolving 3 g of hydrochloric acid (being at 12N) in 235 g of water was slowly dripped into this solution at room temperature. After that, the mixture was stirred at room temperature over three hours.

Evaluation

Uniformity in film thickness was tested using the same method as that of Example 1 for each of Samples Nos. 201-209. Evaluation was conducted according to the same evaluation ranking method as that for Example 1. The result of evaluation is shown in following Table 2.

TABLE 2

| | Change in back | | |
|---|---|---|---|
| | pressure of the | | |
| | conveyance apparatus | | |
| | after coating the | | |
| | intermediate | | |
| | refractive layer | | |
| | coating solution, | | |
| | high refractive | | |
| | layer coating | | |
| | solution and low | | |
| | refractive layer | Uniformity | |
| Sample | coating solution | of film | |
| No. | (Pa) | thickness | Remarks |
| 201 | 3 | E | Comparative example |
| 202 | 10 | C | Present invention |
| 203 | 30 | B | Present invention |
| 204 | 100 | A | Present invention |
| 205 | 300 | A | Present invention |
| 206 | 500 | A | Present invention |
| 207 | 800 | B | Present invention |
| 208 | 1,000 | C | Present invention |
| 209 | 1,200 | E | Comparative example |

The foregoing evaluation test demonstrates the validity of the present invention.

### Example 3

<<Preparation of Cellulose Ester Film>>

Using the same material and method as those used in Example 1, both edges of the film were knurled to a width of 10 mm and a height of 10 μm, whereby a long and wide cellulose ester film was produced. This film had a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1, using an extrusion type die coater. The film was float-conveyed while the conveyance rate was regulated as required, to ensure that the solid concentration M at the terminal point of the first drying apparatus would be as shown in Table 3. Otherwise, the procedure was carried out under the same condition as those of Sample No. 104. Thus, a coated layer was formed and cooled to room temperature. Then the film was wound on a core in the recovery section, whereby Samples Nos. 301-304 were produced.

After the process of coating was completed, while ensuring that the wet film thickness would be 10 μm, the cellulose ester film carrying a clear hard-coat layer was dried in the first drying section maintained at a dry air temperature of dry air of 70° C.

Evaluation

Uniformity in film thickness was checked using the same method as that of Example 1 for each of Samples Nos. 301-304. Evaluation was done using the same evaluation ranking as that of Example 1, which are shown in Table 3 below.

TABLE 3

| | Conveyance | Solid | |
|---|---|---|---|
| Sample | rate | concentration | Uniformity of |
| No. | (m/min) | M (%) | film thickness |
| 301 | 30 | 85 | A |
| 302 | 35 | 80 | A |
| 303 | 40 | 70 | B |
| 304 | 50 | 50 | C |

The foregoing evaluation test demonstrates the validity of the present invention.

### Example 4

<<Preparation of Cellulose Ester Film>>

Using the same materials and methods as those used in Example 1, both edges of the film were knurled to a width of 10 mm and a height of 10 μm, whereby a long and wide cellulose ester film was produced, this being specifically a film of a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1 by an extrusion type die coater so that the wet film thickness was 10 μm at a conveyance rate of 30 m/min. Then the cellulose ester film carrying a clear hard-coat layer was dried in 70° C. dry air in the first drying zone. This was followed by regulating the velocity as shown in Table 4 of the gas blown from the blow outlets along the direction of conveyance of the cellulose ester-film carrying the clear hard-coat layer coated film by a conveyance apparatus, whereby the maximum value of the back pressure against the uncoated surface due to gas was regulated. Otherwise, the same conditions as those for Sample No. 104 in Example 1 were used to form the coated layer. Then the temperature was cooled to room temperature, and the film was wound on a core in the recovery section, whereby Samples Nos. 401-408 were produced.

Evaluation

Uniformity in film thickness was tested according to the same method as that for Example 1 for each of Sample Nos. 401-408. Evaluation was made according to the same ranking as that of Example 1. The evaluation results are shown in following Table 4.

TABLE 4

| | | Maximum back | |
|---|---|---|---|
| | Blow-out gas | pressure of | |
| Sample | velocity | floating-support | Uniformity of |
| No. | (m/min) | (Pa) | film thickness |
| 401 | 3 | 9 | D |
| 402 | 5 | 10 | B |
| 403 | 10 | 50 | A |
| 404 | 15 | 100 | A |
| 405 | 25 | 400 | C |
| 406 | 35 | 800 | C |
| 407 | 40 | 1,000 | C |
| 408 | 42 | 1,100 | D |

The foregoing evaluation test demonstrates the validity of the present invention.

### Example 5

<<Preparation of Cellulose Ester Film>>

Using the same materials and methods as those used in Example 1, both edges of the film were knurled to a width of 10 mm and a height of 10 μm, and a long and wide cellulose ester film was produced, specifically this film had a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1 by an extrusion type die coater so that the wet film thickness was 10 μm at a conveyance rate of 30 m/min. Then the cellulose ester film carrying a clear hard-coat layer was dried by 70° C. dry air in the first drying zone. The intervals of change of the back pressure against the uncoated surface due to gas were regulated along the direction of conveyance, as shown in Table 5. Otherwise, the same conditions as those for Sample No. 104 in Example 1 were used to form the coated layer. Then the temperature was cooled to room temperature, and the film was wound on a core in the recovery section, whereby Sample Nos. 501-504 were produced.

Evaluation

Uniformity in film thickness was checked using the same method as that of Example 1 for each of Sample Nos. 501-504. Evaluation was made using the same ranking as that of Example 1. The result are shown in following Table 5.

TABLE 5

| | Total length of | |
|---|---|---|
| | substrate of adjacent | |
| | raised portion | |
| | (Floating support unit) | |
| | and squared notch along | Uniformity of |
| Sample | conveyance direction | film |
| No. | (mm) | thickness |
| 501 | 50 | B |
| 502 | 220 | A |
| 503 | 480 | B |
| 504 | 660 | D |

The foregoing evaluation demonstrates the validity of the present invention.

### Example 6

<<Preparation of Cellulose Ester Film>>

Using the same materials and methods as those for Example 1, both edges of the film were knurled to a width of 10 mm and a height of 10 μm, whereby a long and wide cellulose ester film was produced. This film had a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1 by an extrusion type die coater so that the wet film thickness was 10 μm at a conveyance rate of 30 m/min. Then the cellulose ester film, carrying a clear hard-coat layer, was dried by 70° C. dry air in the first drying zone. When the cellulose ester film, carrying a clear hard-coat layer, was dried while being float-supported and conveyed by the conveyance apparatus, the total area of the supper surfaces of the floating units of the conveyance apparatus was regulated with respect to the area of the uncoated surface of the coated layer float-supported by the gas blown from a plurality of blowing outlets of a plurality of floating support units, as shown in Table 6. Otherwise, the same conditions as those for Sample No. 104 in Example 1 were used to form the coated layer. Then the temperature was cooled to room temperature, and the film was wound on a core in the recovery section, whereby Sample Nos. 601-605 were produced.

Evaluation

Uniformity in film thickness was checked using the same method as that of Example 1 for each of Sample Nos. 601-605. Evaluation was made using the same ranking as that of Example 1. The evaluation results are shown in following Table 6.

TABLE 6

| | Pitch of floating | | |
|---|---|---|---|
| | support units | Back pressure | |
| | arranged along the | surface:non- | |
| | direction of | back pressured | Uniformity of film |
| Sample No. | conveyance (mm) | surface | thickness |
| 601 | 450 | 4.9:5.1 | C |
| 602 | 350 | 6.3:3.7 | B |
| 603 | 300 | 7.3:2.7 | A |
| 604 | 250 | 8.8:1.2 | B |
| 605 | 230 | 9.6:0.4 | C |

The foregoing evaluation demonstrates the validity of the present invention.

<<Preparation of Cellulose Ester Film>>

Using the same materials and methods as those used in Example 1, both edges of the film were knurled to a width of 10 mm and a height of 10 μm, and a long and wide cellulose ester film was produced. This film had a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1 by an extrusion type die coater to a wet film thickness of 10 μm at a conveyance rate of 30 m/min. Then the cellulose ester film carrying a clear hard-coat layer was dried by 70° C. dry air in the first drying zone. When the cellulose ester film carrying a clear hard-coat layer was dried while being float-supported and conveyed by the conveyance apparatus, the distance from the floating gas header installation surface for the floating support units of the conveyance apparatus to the uncoated surface was regulated with respect to the distance from the upper surfaces of the floating units to the uncoated surface, as shown in Table 7. Otherwise, the same conditions as those for Sample No. 104 in Example 1 were used to form the coated layer. Then the temperature was cooled to room temperature, and the film was wound on a core in the recovery section, whereby Sample Nos. 701-705 were produced.

Evaluation

Uniformity in film thickness was checked using the same method as that of Example 1 for each of Sample Nos. 701-705. Evaluation was made using the same ranking as that of Example 1. The evaluation results are shown below in Table 7.

TABLE 7

| | Ratio (factor of increase) of the | |
|---|---|---|
| | distance from the floating gas | |
| | header installation surface for the | |
| | floating support unit to the | |
| | uncoated surface, with respect to | |
| | the distance from the blow-out | |
| Sample | surface of the floating unit to the | Uniformity of |
| No. | uncoated surface | film thickness |
| 701 | 4 | C |
| 702 | 5 | B |
| 703 | 6 | A |
| 704 | 8 | A |
| 705 | 10 | A |

The foregoing evaluation demonstrates the validity of the present invention.

### Example 8

<<Preparation of Cellulose Ester Film>>

Using the same materials and methods as those used in Example 1, both edges of the film were knurled to a width of 10 mm and a height of 10 μm, and a long and wide cellulose ester film was produced. This film had a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1 by an extrusion type die coater at a wet film thickness of 10 μm at a conveyance rate of 30 m/min. Then the cellulose ester film carrying a clear hard-coat layer was dried by 70° C. dry air in the first drying zone. When the cellulose ester film carrying a clear hard-coat layer was dried while being float-supported and conveyed by the conveyance apparatus, the crosswise width of the cellulose ester film carrying a clear hard-coat layer on the upper surface of the floating support unit of the conveyance apparatus was changed with respect to the width of the cellulose ester film, as shown in Table 8. Otherwise, the same conditions as those for Sample No. 104 in Example 1 were used to form the coated layer. Then the temperature was cooled to room temperature, and the film was wound on a core in the recovery section, whereby Sample Nos. 801-807 were produced. In this case, the width was changed by a combination of the steps of reducing the film width by slitting the edges of the cellulose ester film and blocking the end of the blow outlets with adhesive tape.

Evaluation

Uniformity in film thickness was checked using the same method as that of Example 1 for each of Sample Nos. 801-807. Evaluation was made using the same ranking as that of Example 1. The evaluation results are shown in Table 8.

TABLE 8

| | Width of the cellulose ester film on | Uniformity |
|---|---|---|
| | the upper surface of the floating | of |
| Sample | support units, compared to the width | film |
| No. | of the cellulose ester film (mm) | thickness |
| 801 | +80 | C |
| 802 | +60 | B |
| 803 | +20 | A |
| 804 | ±0 | A |
| 805 | −20 | A |
| 806 | −60 | B |
| 807 | −80 | C |

The foregoing evaluation demonstrates the validity of the present invention.

### Example 9

<<Preparation of Cellulose Ester Film>>

Using the same materials and methods as those used in Example 1, both edges of the film were knurled to a width of 10 mm and a height of 10 μm, and a long and wide cellulose ester film was produced. This film had a thickness of 80 μm, a width of 1,400 mm, and a length of 2,500 m.

<<Formation of Clear Hard-Coat Layer>>

Using the coating/drying apparatus of FIG. 1, the following steps formed a clear hard-coat layer. One surface of the cellulose ester film was coated with the same clear hard-coat layer coating solution as that of Example 1 by an extrusion type die coater so that the wet film thickness was 10 μm at a conveyance rate of 30 m/min. Then the cellulose ester film carrying a clear hard-coat layer was dried by 70° C. dry air in the first drying zone. When the cellulose ester film carrying a clear hard-coat layer was dried while float-supported and conveyed by the conveyance apparatus, the curvature radius of the installation surface of the floating support units of the floating gas header in the conveyance apparatus, was modified and the curvature radius of the floating support units was changed to install the floating support units in an arched form, as shown in Table 9. Otherwise, the same conditions as those for Sample No. 104 in Example 1 were used to form the coated layer. Then the temperature was cooled to room temperature, and the film was wound on a core in the recovery section, whereby Sample Nos. 901-908 were produced. In this case, the curvature radius of the floating support units in an arched form by changing the curvature radius was the curvature radius of the floating support unit installation surface for the floating gas header.

Evaluation

Uniformity in film thickness was checked using the same method as that of Example 1 for each of Sample Nos. 901-908. Evaluation was made using the same ranking as that of Example 1. The evaluation results are shown in Table 9.

TABLE 9

| | Curvature radius | |
|---|---|---|
| | of the installation | |
| Sample | surface of the floating | Uniformity of |
| No. | support unit (m) | film thickness |
| 901 | 3 | C |
| 902 | 5 | B |
| 903 | 10 | A |
| 904 | 30 | A |
| 905 | 50 | A |
| 906 | 80 | A |
| 907 | 100 | B |
| 908 | 120 | C |

The foregoing evaluation demonstrates the validity of the present invention.

### Example 10

(Preparation of Substrate)

A polyethylene terephthalate (PET) film having a thickness of 75 μm, a width of 600 mm and a length of 1,000 m was prepared. The glass transition temperature of this PET film was 140° C.

(Preparation of Coating Solution)

A coating solution was prepared by dissolving polyvinyl alcohol in pure water so that the solids concentration would be 1% by mass. This coating solution was measured by a B type viscometer to determine the viscosity at 25° C., which resulted in a value of 5.2 mPa·s.

(Coating)

Using the coating/drying apparatus of FIG. 1, the following steps were taken to conduct the process of coating. One surface of the produced cellulose ester film was coated with the coating solution, at a conveyance rate of 50 m/min. by an extrusion type die coater at a wet film thickness of 10 μm. Then the PET film carrying the coated layer was dried by 60° C. dry air in the first drying zone. While regulating the back pressure against the uncoated surface via forced gas along the direction of the conveyance of the PET film, carrying the coated layer by the conveyance apparatus as shown in Table 10, the film was float-supported and conveyed while the solids concentration in the coated layer did not exceed 80% by volume. After that, the residual solvent in the coated layer was evaporated and removed at a drying temperature of 100° C. in the second drying zone. Then the temperature was cooled to room temperature, and then the film was wound on a core in the recovery section, whereby Sample Nos. 1001-1009 were produced.

<<Conveyance by the First Drying Apparatus>>

Floating support units having a width of 650 mm (being along the width direction of the substrate) and a length of 220 mm (being along the direction of conveyance of the substrate), were employed.

Blowing outlets of the floating support unit had a width of 630 mm (being along the width direction of the substrate), a gap of 3 mm (being along the direction of conveyance of the substrate), and the outlets were three provided with pitches of 100 mm along the direction of conveyance of the substrate.

Twenty floating support units were arranged in the form of an arch on the installation surface of the floating gas header having an arch diameter of 10 m (the coordinate arrangement at the central position along the direction of conveyance of the upper surface of the floating support units) at a pitch of 300 mm, wherein the difference of the height between the upper surface of the floating support unit and the installation surface was 150 mm.

The foregoing PET film was conveyed in a floating state by the conveyance apparatus equipped with the floating support units. This procedure ensured that the ratio between the area where the PET film supported by the floating units and the area where the film was not supported was 7.3:2.7, the width of the blow outlets was +30 mm with respect to the width of the PET film, and the interval of changes in back pressure was 150 mm along the direction of the conveyance.

Other conditions for the conveyance apparatus were set as follows: The temperature of the gas blown against the uncoated surface from the blow outlets of the floating support units was set at 40° C. (gas temperature indicating the value measured by the temperature measuring tube installed inside the floating support units), the velocity of the gas blown against the uncoated surface from the blow outlets of the floating support units (gas velocity indicating the value measured by the hot-wire anemometer) was set at 15 m/s, and the tension along the direction of conveyance (tension showing the value measured by the tension pickup roller installed inside the conveyance line) was set at 180 N/m.

Thus, the PET film was conveyed under the following conditions: The distance (being the amount of floatation) between the blow-out back pressure surface of the floating support units and the back uncoated surface of the PET film was 15 mm, the distance between the installation surface of the floating support unit and the uncoated surface of the PET film was 165 mm, and the maximum value of the back pressure was 100 Pa. It is to be noted that the back pressure was measured as follows: The SUS-made tube having an outer diameter of 1 mm and an inner diameter of 0.5 mm was inserted between the floating support units and the substrate. Then the static pressure was measured by a Manostar Gauge. This measurement value was a static pressure of the back pressure.

Under the foregoing conditions, the PET film carrying the clear hard-coat layer was conveyed in a floating state by the conveyance apparatus along the direction of conveyance, while the back pressure against the uncoated surface given by gas was changed, as shown in Table 1. The back pressure was regurated by changing the blowing gas velocity. This changed the distance between the PET film and the upper surface of the floating support units.

Evaluation

Uniformity in film thickness was checked using the same method as that of Example 1 for each of Sample Nos. 1001-1009. Evaluation was made using the same ranking method as that of Example 1. The evaluation results are shown in Table 10.

TABLE 10

| | Change in | | |
|---|---|---|---|
| | back | | |
| Sample | pressure | Uniformity of | |
| No. | (Pa) | film thickness | Remarks |
| 1001 | 3 | D | Comparative |
| | | | Example |
| 1002 | 10 | C | Present |
| | | | Invention |
| 1003 | 30 | B | Present |
| | | | Invention |
| 1004 | 100 | A | Present |
| | | | Invention |
| 1005 | 300 | A | Present |
| | | | Invention |
| 1006 | 500 | A | Present |
| | | | Invention |
| 1007 | 800 | B | Present |
| | | | Invention |
| 1008 | 1,000 | C | Present |
| | | | Invention |
| 1009 | 1200 | D | Comparative |
| | | | Example |

The validity of the present invention is verified.

What is claimed is:

1. A method for producing a functional film comprising the steps of:
(a) forming a coated layer by coating with a coating solution onto a substrate being belt-like and continuously conveyed, and the coating solution containing solid components dissolved or dispersed in a solvent, and
(b) drying the coated layer while the substrate with the coated layer is conveyed by supporting in a floating state by blowing a gas to an uncoated surface of the substrate from a conveyance apparatus having a plurality of blowing outlets arranged along the direction of the conveyance of the substrate in a drying process for producing a functional film by removing by evaporation of the solvent from the coated layer,
wherein the conveyance apparatus features alternately squared notches and raised portions having the blowing outlets, and in a plurality of the adjacent raised portions and the squared notches, the gas is blown from the blowing outlets in order to make a difference between (1) and (2) to be not less than 10 Pa and not more than 1,000 Pa; wherein (1) is the back pressure generated between the raised portion and the uncoated surface of the substrate, and (2) is the back pressure generated between the squared notch adjacent to the raised portion and the uncoated surface of the substrate.

2. The method for producing the functional film of claim 1, wherein in the conveyance apparatus, the maximum value of the back pressure at the uncoated surface of the substrate is not less than 10 Pa and not more than 1,000 Pa.

3. The method for producing the functional film of claim 1, wherein a length of the substrate between one of the adjacent raised portion and the squared notch is not less than 50 nm and not more than 500 nm, provided that each pair of the adjacent raised portion and squared notch satisfies the condition of the difference of the back pressure being not less than 10 Pa and not more than 1,000 Pa.

4. The method for producing the functional film of claim 1, wherein support of the substrate is continued while a concentration of solid components in the coated layer is not more than 80 volume %.

5. The method for producing the functional film of claim 1, wherein a ratio of the total area of each (3) and (4) is from 6:4 to 9:1, wherein (3) is a total area of a surface of the raised portion facing an uncoated surface of the substrate and (4) is a total area of a surface of the squared notch facing the uncoated surface of the substrate, provided that each pair of the adjacent raised portion and squared notch satisfies the condition of the difference of the back pressure being not less than 10 Pa and not more than 1,000 Pa.

6. The method for producing the functional film of claim 1, wherein a distance between an upper surface of the squared notch and the substrate is bigger than that between an upper surface of the raised portion and the substrate by the factor of not less than five, provided that each pair of the adjacent raised portion and squared notch satisfies the condition of the difference of the back pressure being not less than 10 Pa and not more than 1,000 Pa.

7. The method for producing the functional film of claim 1, wherein a length of the blowing outlets in a width direction of the substrate is in the range of a width of the substrate ±60 mm, provided that each pair of the adjacent raised portion and squared notch satisfies the condition of the difference of the back pressure being not less than 10 Pa and not more than 1,000 Pa.

8. The method for producing the functional film of claim 1, wherein in the conveying apparatus featuring a plurality of raised portions and a plurality of the squared notches, the raised portions are allocated in an arch by a curvature radius of not less than 5 m and not more than 100 m, and the upper surface of the raised portion featuring the blowing outlets to generate the back pressure is almost parallel to the substrate.

9. The method for producing the functional film of claim 1, wherein a conveying tension of the substrate in the conveying apparatus is not less than 100 N/m and not more than 600 n/m.

10. The method for producing the functional film of claim 1, wherein the substrate conveying in the conveying apparatus is conveyed in a state of arch of a cross-sectional shape perpendicular to the conveying direction with both ends curving down.

11. The method for producing the functional film of claim 1, wherein the functional layer is a hard coat layer.

12. The method for producing the functional film of claim 1, wherein the substrate contains cellulose triacetate.

13. A conveyance apparatus conveying a belt-like and continuously conveyed substrate onto which (a) a coated layer is formed by coating with a coating solution, and the coating solution containing solid components dissolved or dispersed in a solvent, and (b) the coated layer is dried while the substrate with the coated layer is conveyed by supporting it in a floating state by blowing a gas against an uncoated surface of the substrate from a conveyance apparatus featuring a plurality of blowing outlets arranged along the direction of the conveyance of the substrate in a drying process to produce a functional film by evaporation of the solvent from the coated layer,
wherein the squared notches and raised portions having the blowing outlets are alternately provided, and in a plurality of the adjacent raised portions and the squared notches, the gas is blown from the blowing outlets in order to produce a difference between back pressure (1) and back pressure (2) to be not less than 10 Pa and not more than 1,000 Pa; wherein (1) is the back pressure generated between the raised portion and the uncoated surface of the substrate, and (2) is the back pressure generated between the squared notch, adjacent to the raised portion, and the uncoated surface of the substrate.

14. The conveyance apparatus of claim 13 above, wherein a maximum value of the back pressure at the uncoated surface of the substrate is not less than 10 Pa and not more than 1,000 Pa.

15. The conveyance apparatus of claim 13, wherein a distance of the substrate between one of the adjacent raised portions and the squared notches is not less than 50 nm and not more than 500 nm, provided that each pair of the adjacent raised portion and squared notch satisfies the condition of the difference of the back pressure being not less than 10 Pa and not more than 1,000 Pa.

16. The conveyance apparatus of claim 13, wherein a ratio of the total areas of each (3) and (4) being from 6:4 to 9:1, wherein (3) is a total surface area of the raised portions facing an uncoated surface of the substrate and (4) is a total surface area of the squared notch facing the uncoated surface of the substrate, provided that each pair of the adjacent raised portion and squared notch satisfies the condition of the difference of the back pressure being not less than 10 Pa and not more than 1,000 Pa.

17. The conveyance apparatus of claims 13, wherein a distance between the upper surface of the squared notches and the substrate is greater than that between an upper surface of the raised portion and the substrate by a factor of not less than five, provided that each pair of the adjacent raised portion and squared notch satisfies the condition of the difference of the back pressure being not less than 10 Pa and not more than 1,000 Pa.

18. The conveyance apparatus of claims 13, wherein a length of the blowing outlets in a width direction of the substrate is in the range of a width of the substrate ±60 mm, provided that each pair of the adjacent raised portion and squared notch satisfies the condition of the difference of the back pressure being not less than 10 Pa and not more than 1,000 Pa.

19. The conveyance apparatus of claim 13, wherein a shape of this a plurality of raised portions and a plurality of the squared notches, the raised portions are allocated in an arch by a curvature radius of not less than 5 m and not more than 100 m, and the upper surface of the raised portion featuring the blowing outlets to generate the back pressure is almost parallel to the substrate.

20. The conveyance apparatus of claim 13, wherein a conveying tension of the substrate is not less than 100 N/m and not more than 600 N/m.

21. A functional film having a hard-coat layer, wherein the functional film is produced with the method for production of claim 1.

22. The functional film having an antireflection layer, wherein the functional film is produced with the method for production of claim 1.
